(19) United States
(12) Patent Application Publication
(10) Pub. No.: US 2024/0276241 A1
(43) Pub. Date: Aug. 15, 2024

(54) FUNCTIONALITY BASED TWO-SIDED MACHINE LEARNING OPERATIONS

(71) Applicant: QUALCOMM Incorporated, San Diego, CA (US)

(72) Inventors: Rajeev KUMAR, San Diego, CA (US); Eren BALEVI, Brooklyn, NY (US); Srinivas YERRAMALLI, San Diego, CA (US); Taesang YOO, San Diego, CA (US); Naga BHUSHAN, San Diego, CA (US)

(21) Appl. No.: 18/408,060

(22) Filed: Jan. 9, 2024

Related U.S. Application Data
(60) Provisional application No. 63/484,453, filed on Feb. 10, 2023.

(51) Int. Cl. H04W 24/02; H04L 41/16

(52) U.S. Cl. CPC H04W 24/02; H04L 41/16

(57) ABSTRACT

An apparatus, method and computer-readable media are disclosed for performing wireless communications. For example, a process for wireless communications is provided. The process can include receiving a first set of operations supported by one or more machine learning models of a network entity, receiving a first set of parameters associated with the first set of operations, wherein the first set of parameters are supported by the one or more machine learning models of the network entity, selecting a machine learning model for performing a first operation of the first set of operations based on the first set of parameters, detecting a change in at least one of: the first operation, or a parameter associated with the first operation, and transmitting an indication to change the first operation based on the detected change.

### CROSS-REFERENCE TO RELATED APPLICATIONS

This application claims the benefit of U.S. Provisional Application No. 63/484,453, filed Feb. 10, 2023, which is hereby incorporated by reference in its entirety and for all purposes.

### FIELD

The present disclosure generally relates to artificial intelligence (AI) and/or machine learning (ML) systems for wireless communications. For example, aspects of the present disclosure relate to systems and techniques for providing functionality based two-sided ML/AI operations for wireless communication systems.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML-based algorithms may be incorporated into the 5G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some cases, multiple ML models may be used by devices (e.g., user equipment (UE) and network devices) to implement functions that may be used to communicate with other devices (e.g., UE to network devices, network devices to UE, etc.). The ML models may perform operations based on different parameters. In cases where both a UE and a network entity are using ML models to perform corresponding operations (e.g., one or more ML models of the UE being used for generating channel state information (CSI) information, one or more ML models of the network device being used for decoding the CSI information, and/or other operations), the UE and network entity should use compatible ML models. A technique to coordinate ML model operations between two sides (e.g., between two networked devices such as a UE and a network device) may be useful.

Systems and techniques are described herein for providing functionality based two-sided

ML/AI operations for wireless communication systems. For instance, the systems and techniques can provide functionality-based assistance information and/or indications between wireless devices, which may be used for coordinating ML model usage for compatibility while avoiding disclosing identification of ML models of one or more of the wireless devices. In some aspects, the systems and techniques may provide information associated with the operations performed by machine learning techniques for a UE and/or network device. For example, the UE (or the network device) can provide an indication of the operations that may be performed by ML models to the network device (or the UE). In some cases, parameters associated with the operations may also be provided. Based on the provided indication of the operations provided by the UE, the network device may detect changes in the operations performed by ML models, or changes in the parameters used by the ML models, and the network may indicate, such as via an activation/deactivation message or assistance information, to the UE that adjustments to the ML models used by the UE to perform corresponding operations may be changed. Similarly, the UE may detect changes in the operations performed by ML models, or changes in the parameters used by the ML models, and the UE may indicate, such as via an activation/deactivation message, to the network device that adjustments to the ML models used by the network device to perform corresponding operations may be changed.

In one illustrative example, an apparatus for wireless communications is provided. The apparatus includes at least one memory and at least one processor coupled to the at least one memory. The at least one processor being configured to: receive a first set of operations supported by one or more machine learning models of a network entity; receive a first set of parameters associated with the first set of operations, wherein the first set of parameters are supported by the one or more machine learning models of the network entity; select a machine learning model for performing a first operation of the first set of operations based on the first set of parameters; detect a change in at least one of: the first operation; or a parameter associated with the first operation; and transmit an indication to change the first operation based on the detected change.

As another example, a method for wireless communications is provided. The method includes: receiving a first set of operations supported by one or more machine learning models of a network entity; receiving a first set of parameters associated with the first set of operations, wherein the first set of parameters are supported by the one or more machine learning models of the network entity; selecting a machine learning model for performing a first operation of the first set of operations based on the first set of parameters; detecting a change in at least one of: the first operation; or a parameter associated with the first operation; and transmitting an indication to change the first operation based on the detected change.

In another example, a non-transitory computer-readable medium having stored thereon instructions is provided. The instructions, when executed by at least one processor, cause the at least one processor to: receive a first set of operations supported by one or more machine learning models of a network entity; receive a first set of parameters associated with the first set of operations, wherein the first set of parameters are supported by the one or more machine learning models of the network entity; select a machine learning model for performing a first operation of the first set of operations based on the first set of parameters; detect a change in at least one of: the first operation; or a parameter associated with the first operation; and transmit an indication to change the first operation based on the detected change.

As another example, an apparatus for wireless communications is provided. The apparatus includes: means for receiving a first set of operations supported by one or more machine learning models of a network entity; means for receiving a first set of parameters associated with the first set of operations, wherein the first set of parameters are supported by the one or more machine learning models of the network entity; means for selecting a machine learning model for performing a first operation of the first set of operations based on the first set of parameters; means for detecting a change in at least one of: the first operation; or a parameter associated with the first operation; and means for transmitting an indication to change the first operation based on the detected change.

In another example, an apparatus for wireless communications is provided. The apparatus includes at least one memory and at least one processor coupled to the at least one memory. The at least one processor being configured to: receive an indication of a first set of operations supported by one or more machine learning models of a network entity; select a machine learning model for performing a first operation of the first set of operations; detect a change in at least one of: the first operation; or a parameter associated with the first operation; and transmit an indication to change the first operation based on the detected change.

As another example, a method for wireless communications is provided. The method includes: receiving an indication of a first set of operations supported by one or more machine learning models of a network entity; selecting a machine learning model for performing a first operation of the first set of operations; detecting a change in at least one of: the first operation; or a parameter associated with the first operation; and transmitting an indication to change the first operation based on the detected change.

In another example, a non-transitory computer-readable medium having stored thereon instructions is provided. The instructions, when executed by at least one processor, cause the at least one processor to: receive an indication of a first set of operations supported by one or more machine learning models of a network entity; select a machine learning model for performing a first operation of the first set of operations; detect a change in at least one of: the first operation; or a parameter associated with the first operation; and transmit an indication to change the first operation based on the detected change.

As another example, an apparatus for wireless communications is provided. The apparatus includes: means for receiving an indication of a first set of operations supported by one or more machine learning models of a network entity; means for selecting a machine learning model for performing a first operation of the first set of operations; means for detecting a change in at least one of: the first operation; or a parameter associated with the first operation; and means for transmitting an indication to change the first operation based on the detected change.

In another example, an apparatus for wireless communications is provided. The apparatus includes at least one memory and at least one processor coupled to the at least one memory. The at least one processor being configured to: determine a first set of operations supported by one or more machine learning models of the apparatus; determine a first set of parameters associated with the first set of operations, wherein the first set of parameters are supported by the one or more machine learning models of the apparatus; transmit, to a network entity, the first set of operations and the first set of parameters; detect a change in at least one of: a first operation of the first set of operations; or a parameter associated with the first operation; and transmit an indication to change from the first operation based on the detected change.

As another example, a method for wireless communications is provided. The method includes: determining a first set of operations supported by one or more machine learning models of the apparatus; determining a first set of parameters associated with the first set of operations, wherein the first set of parameters are supported by the one or more machine learning models of the apparatus; transmitting, to a network entity, the first set of operations and the first set of parameters; detecting a change in at least one of: a first operation of the first set of operations; or a parameter associated with the first operation; and transmitting an indication to change from the first operation based on the detected change.

In another example, a non-transitory computer-readable medium having stored thereon instructions is provided. The instructions, when executed by at least one processor, cause the at least one processor to: determine a first set of operations supported by one or more machine learning models of the apparatus; determine a first set of parameters associated with the first set of operations, wherein the first set of parameters are supported by the one or more machine learning models of the apparatus; transmit, to a network entity, the first set of operations and the first set of parameters; detect a change in at least one of: a first operation of the first set of operations; or a parameter associated with the first operation; and transmit an indication to change from the first operation based on the detected change.

As another example, an apparatus for wireless communications is provided. The apparatus includes: means for determining a first set of operations supported by one or more machine learning models of the apparatus; means for determining a first set of parameters associated with the first set of operations, wherein the first set of parameters are supported by the one or more machine learning models of the apparatus; means for transmitting, to a network entity, the first set of operations and the first set of parameters; means for detecting a change in at least one of: a first operation of the first set of operations; or a parameter associated with the first operation; and means for transmitting an indication to change from the first operation based on the detected change.

In another example, an apparatus for wireless communications is provided. The apparatus includes at least one memory and at least one processor coupled to the at least one memory. The at least one processor being configured to: transmit a first set of operations supported by one or more machine learning models of the apparatus; transmit a first set of parameters associated with the first set of operations, the first set of parameters indicating parameters supported by the one or more machine learning models of the apparatus; receive a message, the message being based on an output of a machine learning model of a wireless device, wherein the output is based on the first set of operations and the first set of parameters; receive an indication to change a first operation of the first set of operations based on a change detected by the wireless device; and change the first operation based on the indication to change.

As another example, a method for wireless communications is provided. The method includes transmitting a first set of operations supported by one or more machine learning models of the apparatus; transmitting a first set of parameters associated with the first set of operations, the first set of parameters indicating parameters supported by the one or more machine learning models of the apparatus; receiving a message, the message being based on an output of a machine learning model of a wireless device, wherein the output is based on the first set of operations and the first set of parameters; receiving an indication to change a first operation of the first set of operations based on a change detected by the wireless device; and changing the first operation based on the indication to change.

In another example, a non-transitory computer-readable medium having stored thereon instructions is provided. The instructions, when executed by at least one processor, cause the at least one processor to: transmit a first set of operations supported by one or more machine learning models of the apparatus; transmit a first set of parameters associated with the first set of operations, the first set of parameters indicating parameters supported by the one or more machine learning models of the apparatus; receive a message, the message being based on an output of a machine learning model of a wireless device, wherein the output is based on the first set of operations and the first set of parameters; receive an indication to change a first operation of the first set of operations based on a change detected by the wireless device; and change the first operation based on the indication to change.

As another example, an apparatus for wireless communications is provided. The apparatus includes means for transmitting a first set of operations supported by one or more machine learning models of the apparatus; means for transmitting a first set of parameters associated with the first set of operations, the first set of parameters indicating parameters supported by the one or more machine learning models of the apparatus; means for receiving a message, the message being based on an output of a machine learning model of a wireless device, wherein the output is based on the first set of operations and the first set of parameters; means for receiving an indication to change a first operation of the first set of operations based on a change detected by the wireless device; and means for changing the first operation based on the indication to change.

In another example, an apparatus for wireless communications is provided. The apparatus includes at least one memory and at least one processor coupled to the at least one memory. The at least one processor being configured to: transmit an indication of a first set of operations supported by one or more machine learning models of the apparatus; receive a message, the message being based on an output of a machine learning model of a wireless device, wherein the output is based on the first set of operations; receive an indication to change a first operation of the first set of operations based on a change detected by the wireless device; and change the first operation of the apparatus based on the indication to change.

As another example, a method for wireless communications is provided. The method includes transmitting an indication of a first set of operations supported by one or more machine learning models of the apparatus; receiving a message, the message being based on an output of a machine learning model of a wireless device, wherein the output is based on the first set of operations; receiving an indication to change a first operation of the first set of operations based on a change detected by the wireless device; and changing the first operation of the apparatus based on the indication to change.

In another example, a non-transitory computer-readable medium having stored thereon instructions is provided. The instructions, when executed by at least one processor, cause the at least one processor to: transmit an indication of a first set of operations supported by one or more machine learning models of the apparatus; receive a message, the message being based on an output of a machine learning model of a wireless device, wherein the output is based on the first set of operations; receive an indication to change a first operation of the first set of operations based on a change detected by the wireless device; and change the first operation of the apparatus based on the indication to change.

As another example, an apparatus for wireless communications is provided. The apparatus includes means for transmitting an indication of a first set of operations supported by one or more machine learning models of the apparatus; means for receiving a message, the message being based on an output of a machine learning model of a wireless device, wherein the output is based on the first set of operations; means for receiving an indication to change a first operation of the first set of operations based on a change detected by the wireless device; and means for changing the first operation of the apparatus based on the indication to change.

In another example, an apparatus for wireless communications is provided. The apparatus includes at least one memory and at least one processor coupled to the at least one memory. The at least one processor being configured to: receive a first set of operations supported by one or more machine learning models of a wireless device; receive a first set of parameters associated with the first set of operations, the first set of parameters indicating parameters supported by the one or more machine learning models of the wireless device; perform a first operation from the first set of operations using a machine learning model of the apparatus based on the received first set of operations; receive an indication to change a first operation of the first set of operations based on a change detected by the wireless device; and change the first operation of the apparatus based on the indication to change.

As another example, a method for wireless communications is provided. The method includes receiving a first set of operations supported by one or more machine learning models of a wireless device; receiving a first set of parameters associated with the first set of operations, the first set of parameters indicating parameters supported by the one or more machine learning models of the wireless device; performing a first operation from the first set of operations using a machine learning model of the apparatus based on the received first set of operations; receiving an indication to change a first operation of the first set of operations based on a change detected by the wireless device; and changing the first operation of the apparatus based on the indication to change.

In another example, a non-transitory computer-readable medium having stored thereon instructions is provided. The instructions, when executed by at least one processor, cause the at least one processor to: receive a first set of operations supported by one or more machine learning models of a wireless device; receive a first set of parameters associated with the first set of operations, the first set of parameters indicating parameters supported by the one or more machine learning models of the wireless device; perform a first operation from the first set of operations using a machine learning model of the apparatus based on the received first set of operations; receive an indication to change a first operation of the first set of operations based on a change detected by the wireless device; and change the first operation of the apparatus based on the indication to change.

As another example, an apparatus for wireless communications is provided. The apparatus includes means for receiving a first set of parameters associated with the first set of operations, the first set of parameters indicating parameters supported by the one or more machine learning models of the wireless device; means for performing a first operation from the first set of operations using a machine learning model of the apparatus based on the received first set of operations; means for receiving an indication to change a first operation of the first set of operations based on a change detected by the wireless device; and means for changing the first operation of the apparatus based on the indication to change.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6A is a block diagram illustrating an ML engine, in accordance with aspects of the present disclosure;

FIG. 6B is a diagram illustrating an example of a network including ML components, in accordance with aspects of the present disclosure;

FIG. 6C is a diagram illustrating an example of a network including multiple ML components, in accordance with aspects of the present disclosure;

FIG. 7, FIG. 8, and FIG. 9 are sequence diagrams illustrating example techniques for functionality based two-sided machine learning operations, in accordance with aspects of the present disclosure;

FIG. 10, FIG. 11, FIG. 12, FIG. 13, FIG. 14, and FIG. 15 are flow diagrams illustrating example processes for wireless communication, in accordance with aspects of the present disclosure; and

FIG. 16 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface.

In some cases, an access link may support uplink signaling, downlink signaling, connection procedures, etc.

Various systems and techniques are provided with respect to wireless technologies (e.g., The 3GPP 5G/New Radio (NR) Standard) to provide improvements to wireless communications. A device (e.g., a UE) can be configured to generate or determine control information related to a communication channel upon which the device is communicating or is configured to communicate. For example, a UE can monitor a channel to determine information indicating a quality or state of the channel, which can be referred to as channel state information (CSI) or channel state feedback (CSF). The UE can transmit a report, message, or other signaling including the CSI or CSF to a network device, such as a base station (e.g., a gNB) or a portion of the base station (e.g., a central unit (CU), distributed unit (DU), radio unit (RU), Near-Real Time (Near-RT) radio access network (RAN) Intelligent Controller (RIC), or a Non-Real Time (Non-RT) RIC of a gNB).

In some cases, using a machine learning (ML)-based air interface, a first network device (e.g., a UE) and a second network device (e.g., a gNB) may use trained ML models to implement a function. For instance, a UE that intends to convey CSI to a gNB can use a neural network (e.g., an encoder neural network model) to derive a compressed representation (also referred to as a latent representation) of the CSI for transmission to the gNB. The gNB may use another neural network (e.g., a decoder neural network model) to reconstruct the target CSI from the compressed representation.

In some cases, multiple ML models may be used by both UEs and network devices to implement functions that may be used to communicate with other devices (e.g., UE to network devices, network devices to UE, etc.). In cases where both the UE and network entity are using ML models to perform corresponding operations, the UE and network entity should use compatible ML models. In some cases, either or both the UE and the network entity may include one or more ML models for performing certain operations. For example, for an operation such as generating CSI information, a UE may include multiple ML models to generate and/or encode the CSI information for multiple frequency bands, antenna patterns, etc. Each of these ML models may take, as input, different parameters, and the UE may use different ML models for generating the CSI information based on what parameters are present/available. Similarly, the network device (e.g., network entity) may also include different ML models for decoding the CSI information and use of these different ML models may vary based on what parameters were used as input to generate/encode the CSI information. Thus, a technique to coordinate ML model operations between two sides (e.g., between two networked devices such as a UE and a network device) may be useful.

Systems, apparatuses, processes (also referred to as methods), and computer-readable media (collectively referred to herein as “systems and techniques”) are described herein for providing functionality-based assistance information and/or indications between wireless devices, which may be used for coordinating ML model usage for compatibility while avoiding disclosing identification of ML models of one or more of the wireless devices. For instance, the systems and techniques discussed herein can facilitate functionality based two-sided machine learning operations.

The systems and techniques may provide information associated with the operations performed by machine learning techniques for a UE and/or network device. For example, the UE (or the network device) can provide an indication of the operations that may be performed by ML models to the network device (or the UE). In some cases, parameters associated with the operations may also be provided. Based on the provided indication of the operations, the network device may detect changes in the operations performed by ML models, or changes in the parameters used by the ML models, and the network may indicate, such as via an activation/deactivation message or assistance information, to the UE that adjustments to the ML models used by the UE to perform corresponding operations may be changed. Similarly, the UE may detect changes in the operations performed by ML models, or changes in the parameters used by the ML models, and the UE may indicate, such as via an activation/deactivation message, to the network device that adjustments to the ML models used by the network device to perform corresponding operations may be changed.

Determining, encoding, decoding, and CSI (or CSF) will be used herein as an example of operations that may be performed by ML models. However, the systems and techniques described herein can be used for other types of operations that may be performed by ML models, such as those that may be used by a network.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

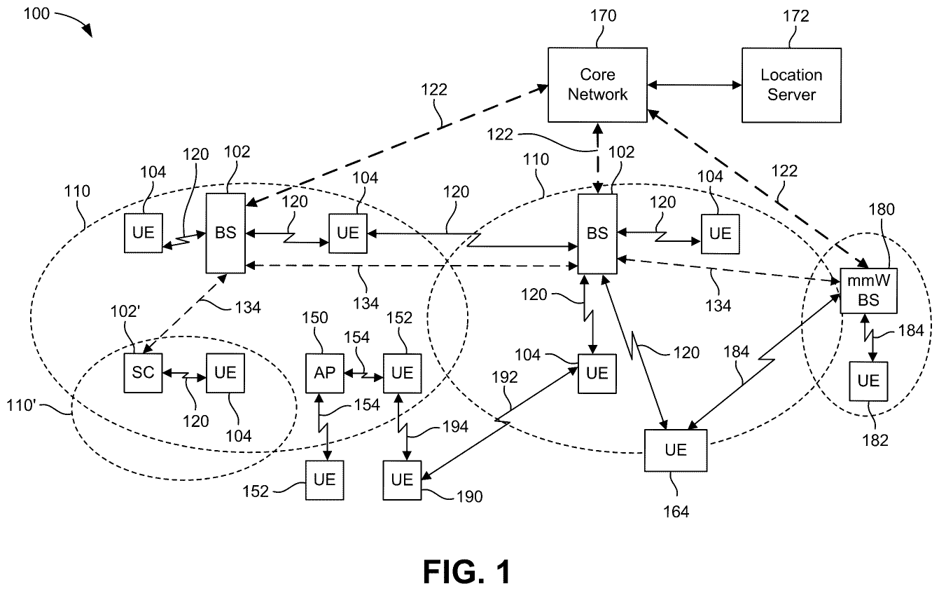

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the

UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as

UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

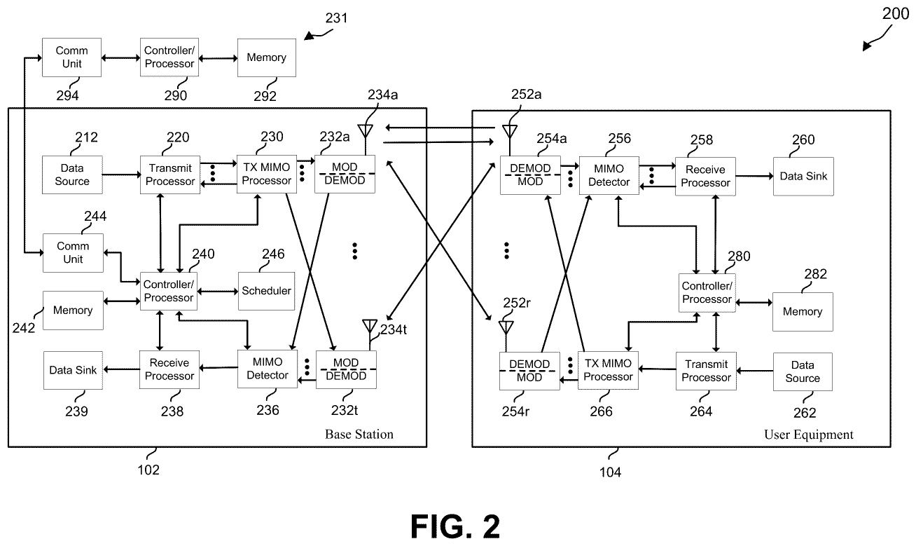

FIG. 2 shows a block diagram of a design of a base station 102 and a UE 104 that enable transmission and processing of signals fexchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing.

Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

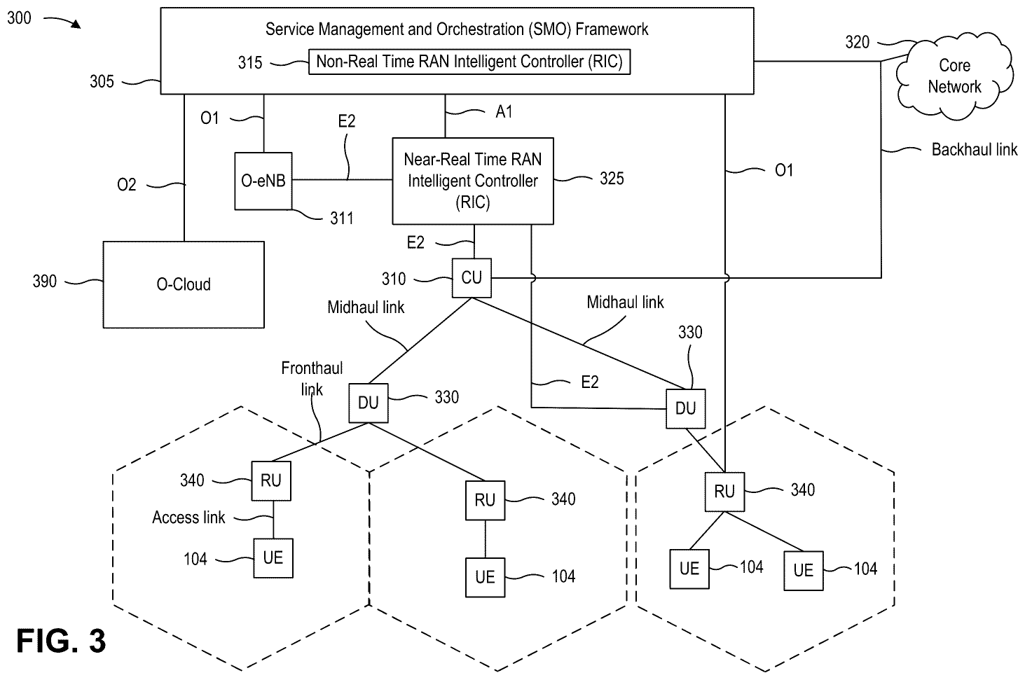

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT

RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform

(FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

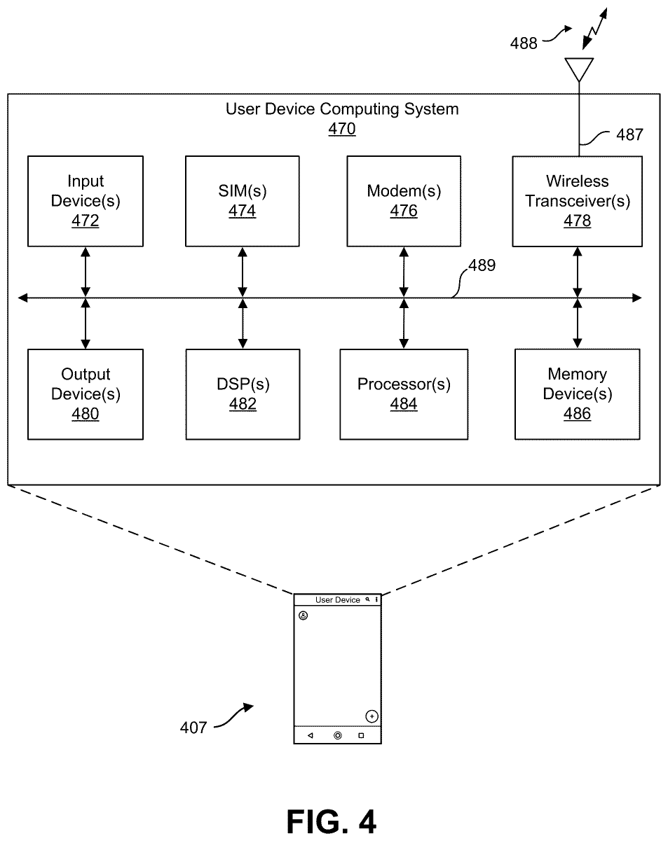

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more central processing units (CPUs), digital signal processors (DSPs), general purpose microprocessors, an application specific integrated circuits (ASICs), field programmable logic arrays (FPGAs), application processors (APs), graphics processing units (GPUs), vision processing units (VPUs), neural processing units (NPUs), neural signal processors (NSPs), microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

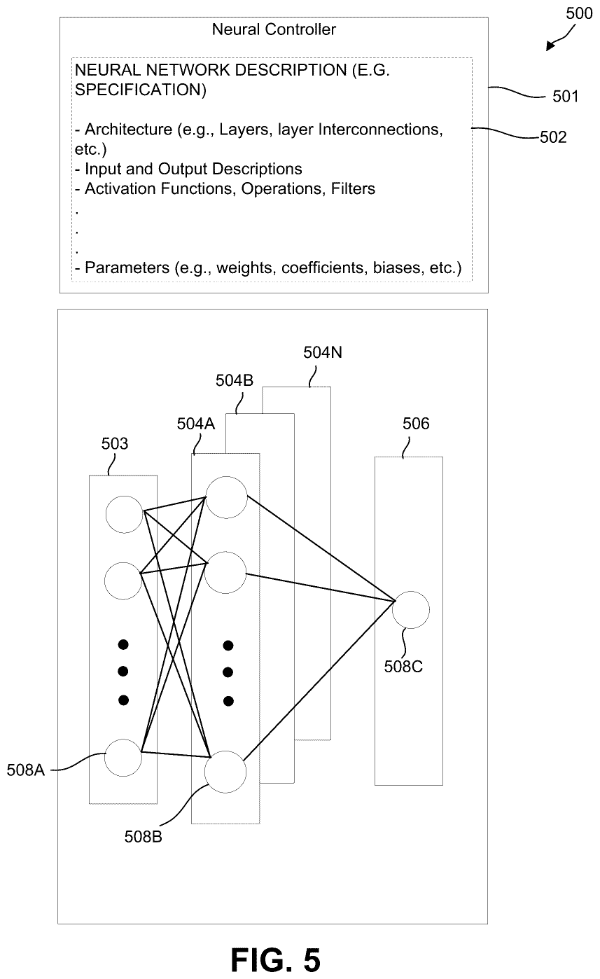

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets

(DBNs), a recurrent neural network (RNN), a generative-adversarial network (GAN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

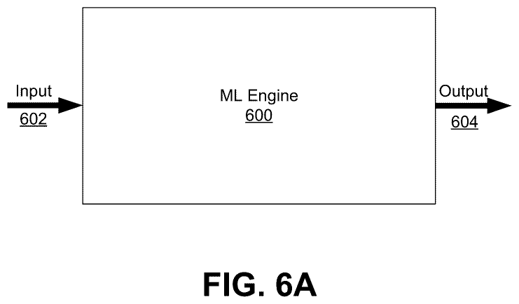

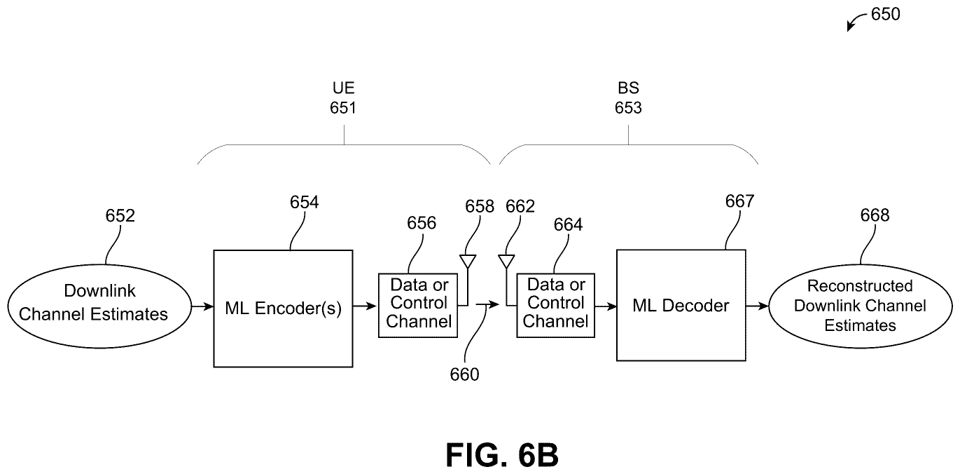

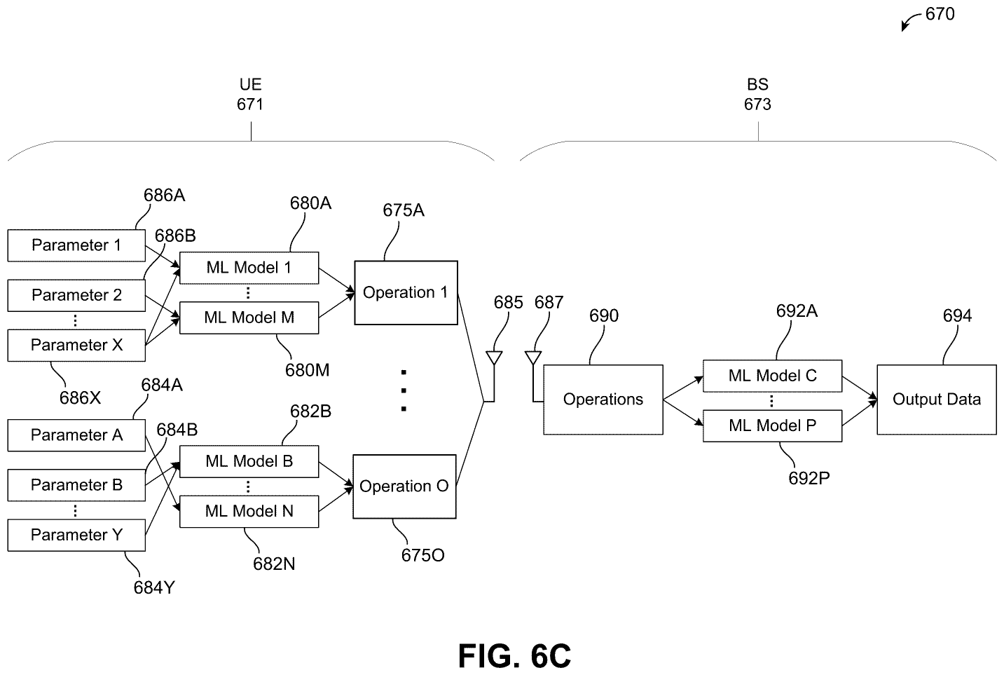

Increasingly ML (e.g., AI) algorithms (e.g., models) are being incorporated into a variety of technologies including wireless telecommunications standards. FIG. 6A is a block diagram illustrating an ML engine 600, in accordance with aspects of the present disclosure. As an example, one or more devices in a wireless system may include the ML engine 600. In some cases, ML engine 600 may be similar to neural network 500. In this example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a discontinuous reception (DRX) schedule for the UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

In some cases, various types of control information and/or system information may be generated and/or processed using ML engines, such as ML engine 600. In another example, the ML engine 600 may be an encoder used to compress information (e.g., channel state information (CSI) or channel state feedback (CSF)) determined by a UE in order to generate a representation (e.g., a latent representation) of the information. In some cases, ML models may also be used by network entities to implement operations. In another example, the ML engine 600 may be a decoder used by a network entity (e.g., a base station) to decode a representation (e.g., a latent representation) of the information (e.g., CSI) generated by a UE.

FIG. 6B is a diagram illustrating an example of a network 650 including a UE 651 and a base station 653 (e.g., a gNB or a portion of a gNB, such as a CU, DU, RU, etc. of a gNB having a disaggregated architecture). As shown in FIG. 6B, downlink channel estimates 652 (e.g., CSI or CSF) are provided to an encoder 654 of the UE 651. The CSI encoder 654 encodes the CSI and the UE 651 transmits the encoded CSI (e.g., a latent representation of the CSI, such as a feature vector representing the CSI) using antenna 658 via a data or control channel 656 over a wireless or air interface 660 to a receiving antenna 662 of the base station 653. In some cases, the UE 651 can transmit a latent message representing the CSI.

The encoded CSI is provided via a data or control channel 664 to a CSI decoder 667 of the base station 653 that can decode the encoded CSI to generate a reconstructed downlink channel estimate 668 (or reconstructed CSI). In some cases, the base station 653 can then determine a precoding matrix, a modulation and coding scheme (MCS), and/or a rank associated with one or more antennas of the base station. Based on the precoding matrix, the MCS, and/or the rank, the base station 653 can determine a configuration of control resources (e.g., via a physical downlink control channel (PDCCH)) or data resources (e.g., via a physical downlink shared channel (PDSCH)).

FIG. 6C is a diagram illustrating an example of a network 670 including a UE 671 and a base station 673 (e.g., a gNB or a portion of a gNB, such as a CU, DU, RU, etc. of a gNB having a disaggregated architecture), in accordance with aspects of the present disclosure. As indicated above, various types of operations may be generated and/or processed using ML engines. In some cases, multiple ML models of UE 671 may generate and/or process a plurality of control information and/or system information based on a plurality of parameters. Different sets of parameters may be input into different ML models for processing to obtain different outputs for different operations.

As an example, a UE may include operation 1 675A . . . operation O 675O (collectively, operations 675). Each operation of operations 675 may be performed by one or more ML models. For example, operation 1 675A may be performed by ML model 1 680A . . . ML model 680M (collectively ML models 680) while operation O may be performed by ML model B 682B . . . ML model N 682N (collectively ML models 682). Each ML model (e.g., ML models 680 and 682) may accept one or more different parameters, such as parameter A 684A, parameter B 684B, . . . parameter Y 684Y, and parameter 1 686A, parameter 2 686B, . . . parameter X 686X, as input.

As a more specific example, operation 1 675A may be generating a CSI report for transmission using ML models 680. The ML models 680 may perform part of generating the CSI report. For example, a ML model of the ML models 680 may perform spatial frequency CSI compression, another ML model of the ML models 680 may perform spatial frequency temporal CSI compression, another ML model of the ML models 680 may perform time domain CSI prediction using UE-sided model, and so forth. The ML models, such as ML models 680 and ML models 682, may take, as input, various parameters. For example, ML model 1 680A may take parameter 1 686A and parameter X 686X as input, while ML model M 680M may take parameter 1 686A and parameter 2 686B as input. Examples of parameters may include, but are not limited to, band/frequency information, subcarrier spacing, a number of TX and RX antenna ports, different Scenario and/or configurations, antenna pattern(s), environment information and/or settings, and the like. Output of the ML models 680 may be combined for the CSI report of operation 1 675A and transmitted to BS 673 via antenna 685 using a data or control channel.

In some cases, the BS 673 may receive information transmitted by the UE 671 via receiving antenna 687. In some cases, one or more operations 690 may be performed to decode, process, transform, etc., the information transmitted by the UE 671. In some cases, these operations 690 may be performed by one or more ML models, such as ML model C 692A, . . . ML model P 692P to generate output data 694.

As discussed above, ML models may be used by either or both a UE and network entity (e.g., BS 673) to implement functions. In cases where both the UE and network entity are using ML models to perform corresponding operations (e.g., encoding a type of CSI information and decoding the encoded CSI information), the UE and network entity should use compatible ML models. In some cases, either or both the UE and the network entity may include one or more ML models for performing certain operations. For example, the UE may include a certain ML model for performing an operation, such as spatial frequency CSI compression, while the network entity includes multiple ML models for performing a corresponding operation, such as decompressing the spatial frequency CSI, and may choose between multiple ML models for performing the corresponding operation (e.g., decompression). Similarly, the UE may, based on changing conditions (e.g., based on a change in input parameters) switch between a first ML model for performing the operation to a second ML model for performing the operation. In some cases, based on this change from the first ML model to the second ML model by the UE, the network entity may also switch ML models (or stop using ML models) for performing the corresponding operation to ensure compatibility. Similarly, the network entity may switch between a third ML model and a fourth ML model, for example, based on changing parameters, and based on this change in ML models by the network entity, the UE may also switch ML models (or stop using ML models). Functionality based two-sided machine learning operations may help facilitate maintaining compatible ML models by providing a framework for providing functionality-based assistance information and/or indications to a corresponding wireless device (e.g., UE or network entity) to ensure ML model compatibility.

In some cases, functionality-based assistance information and/or indications between wireless devices may be useful for coordinating ML model usage for compatibility while avoiding disclosing which ML models are being used. For example, specific details of how a particular ML model or which ML model is being used by a UE may be kept confidential by the UE while still disclosing what operations are being performed by the ML model and what parameters are being input to the ML model (indicating the scenarios, configurations, and other functionality parameters for which UE has relevant models to use) to allow the network entity to select a compatible corresponding ML model (or no ML model).

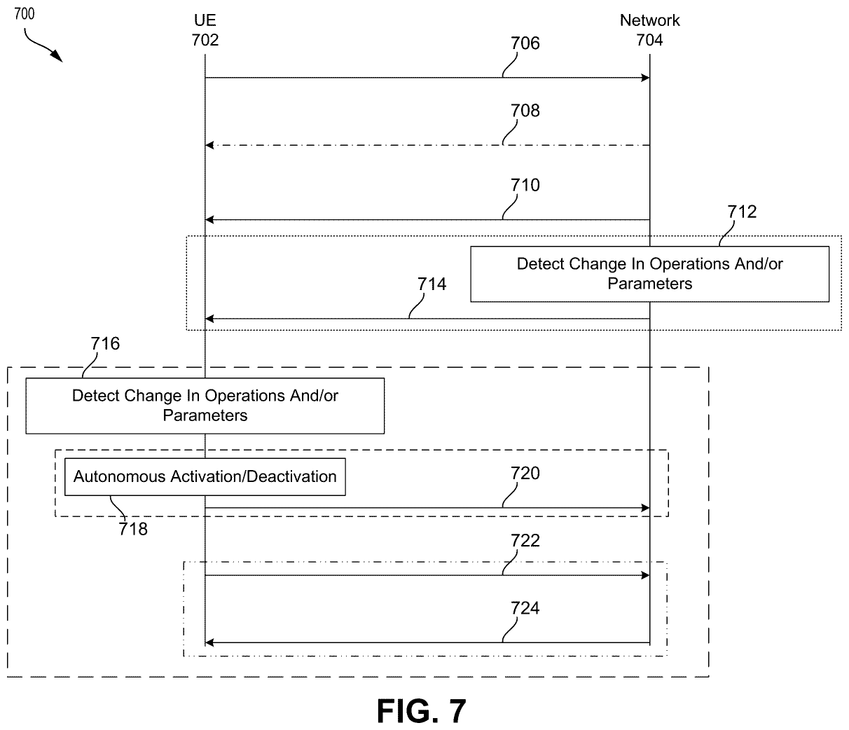

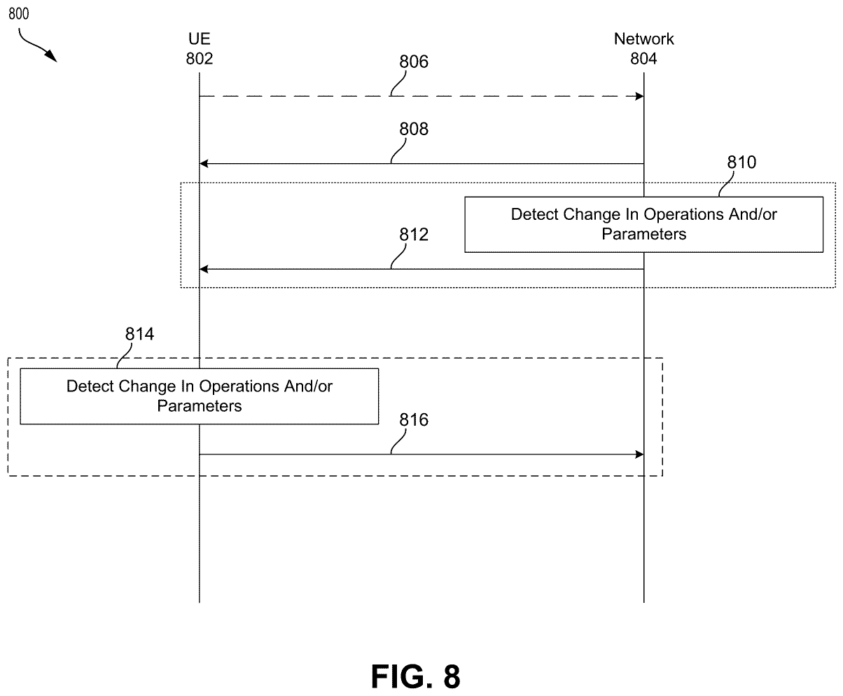

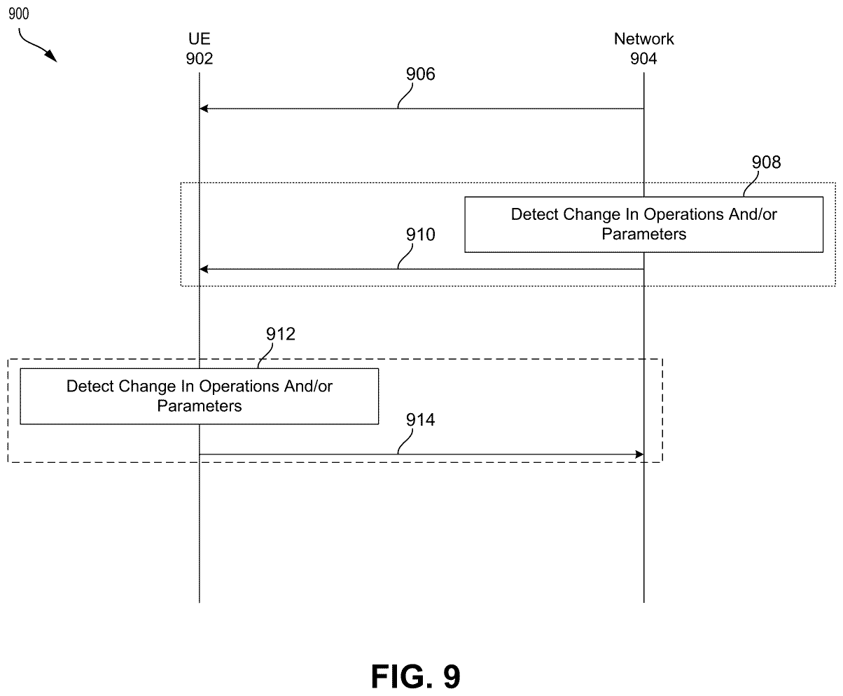

FIG. 7 is a sequence diagram illustrating an example technique 700 for functionality based two-sided machine learning operations, in accordance with aspects of the present disclosure. In technique 700, a UE 702 may be communicatively coupled to a network entity 704 and the UE 702 may transmit 706 an indication of one or more (e.g., a set) UE operations ((e.g., a second set of operations) performed by the UE 702 using ML models to the network entity 704. For example, the UE 702 may indicate a UE operation, such as a type of CSI measurement the UE 702 reports, may be generated using ML models. In some cases, the UE 702 may transmit 706 a set of UE parameters (e.g., a second set of parameters) associated with the ML models being used. For example, portions of the CSI measurement may be generated using one or more ML models and the UE parameters used by those one or more ML models may be indicated to the network entity 704. In some cases, the one or more ML models corresponding to the indicated UE parameters may not be indicated. UE parameters which may be used to generate another portion of the CSI measurement using non-ML techniques may not be indicated to the network entity. In some cases, the set of UE parameters may be those parameters that are input to the ML models being used by the UE. In some cases, the set of parameters (either UE or network entity) may be a listing of the parameters that are input to the ML models (e.g., of the UE or network entity). In other cases, the set of UE parameters may be grouped so the grouping indicates UE parameters that may be input on a per ML model basis. In some cases, there may be an indication of the associated ML model for the grouped UE parameters. In some cases, the parameter indicates the scenarios, configurations, and other operation parameters for which UE has relevant models to use for a given operation or set of operations. In some cases, the set of UE operations may be transmitted 706 via control signaling, such as RRC signaling, as a part of a capability exchange, such as a part of capability information, higher level signaling, or the like. The set of UE parameters may be transmitted 808 along with, or instead of the set of UE operations.

In some cases, optionally, the network entity 704 may transmit 708 an indication of one or more (e.g., a set) network entity operations (e.g., a first set of operations) performed by the network entity 704 using ML models to the UE 702. In some cases, the network entity 704 may transmit 708 a set of network entity parameters (e.g., a first set of parameters) associated with the ML models being used. The set of network entity parameters may be transmitted 808 along with, or instead of the set of network entity operations. In some cases, the set of network entity operations and network entity parameters associated with the set of network entity operation may be indicated in a substantially similar manner by the network entity 704 as by the UE 702, as discussed above. In some cases, the network entity 704 may transmit 708 the indication of the set of network entity operations prior to, concurrent with, or after the UE 702 transmits 706 their indication of the set of network entity operations.

Based on the indicated set of UE operations received from the UE 702, the network entity may determine a set of compatible network entity operations performed by and/or network entity parameters used by ML models of the network entity 704. Based on this determined set of compatible network entity operations and/or network entity parameters, the network entity 704 may select one or more UE operations and/or UE parameters from the set of UE operations and/or UE parameters received from the UE 702 (e.g., in transmission 706). For example, the network entity 704 may support more, all, or less than all of the UE operations and/or UE parameters in the set of UE operations received from UE 702 and the network entity may select the UE operations and/or UE parameters from the set of UE operations and/or UE parameters received from the UE 702. The network entity 704 may then configure 710 the UE 702 to use the one or more UE operations and/or use one or more UE parameters. For example, the network entity 704 may indicate a set of UE operations, a set of UE parameters, and/or a set of UE operations and sets of associated UE parameters that the UE 702 may use for communicating with the network entity. In some cases, the network entity 704 may configure 710 the UE 702 using a UE configuration update procedure or any other procedure for network directed configuration updates for a wireless device.

In some cases, the changes in operations and/or parameters available (e.g., useable) for operations may be detected by either the network entity 704 or the UE 702. For example, environmental changes, such as interference from other wireless devices or weather changes may cause the network entity 704 to determine that a band, frequency, antenna pattern, and/or the like may be adjusted to reduce interference. In some cases, these adjustments may influence network entity operations and/or network entity parameters associated with network entity operations. For example, a network entity operation for decoding a portion of a CSI report may include a first ML model which, as a parameter, operates within a certain frequency range. Thus, a change in the frequency for the portion of the CSI report may result in the first ML model not being used to decode that portion of the CSI report. Instead, a second ML model may be used (or fallback to non-ML based operations).

To ensure compatibility with a corresponding UE ML model, the network entity 704 may detect potential changes in network entity operations and/or network entity parameters 712 to determine whether a corresponding change in UE operations and/or UE parameters may be needed. This determination may be based on the set of UE operations and/or UE parameters received from the UE 702 (e.g., in transmission 706). In some cases, the network entity 704 may send an indication to activate and/or deactivate 714 a use of one or more UE operations and/or UE parameters. In some cases, the indication to activate and/or deactivate 714 may be sent via control signaling, such as using a PDCCH/PDSCH message, RRC message MAC CE, and the like. The UE 702 may then activate/deactivate UE operations and/or use of certain ML models accordingly.

As another example, the UE 702 may determine that a UE operation and/or UE parameter may be changed. For example, in some cases, the UE 702 may detect certain environmental changes, such as moving from an indoor environment to an outdoor environment, and vice versa. Based on these environmental changes the UE 702 may detect potential changes in UE operations and/or UE parameters 716 and determine whether a corresponding change in UE operations and/or UE parameters may be needed. If the UE 702 determines that changes in UE operations and/or UE parameters should be made, in some cases, UE 702 may autonomously activate/deactivate UE operations 718 and/or use of certain ML models accordingly. When the UE 702 is configured to autonomously activate/deactivate UE operations 718 and/or use of certain ML models, the UE 702 may notify 720 the network entity 704 of such UE operation and/or UE parameter changes. In some cases, the UE 702 may then implement the UE operation and/or UE parameter changes, or fallback to non-ML operations. In some cases, the notification 720 of UE operation and/or UE parameter changes may be sent via control signaling, such as using a PUCCH/PUSCH message, RRC message, MAC CE, and the like.

In some cases, such as where the UE 702 is not configured to autonomously activate/deactivate UE operations 718 and/or use of certain ML models, the UE 702 may notify 722 the network entity 704 of the change in UE operations and/or UE parameters. In some cases, the notification 722 of UE operation and/or UE parameter changes may be sent via control signaling, such as using a PUCCH/PUSCH message, RRC message, MAC CE, and the like. Based on the notification 722, the network entity 704 may then configure 724 the UE 702 to use another UE operation and/or use one or more UE parameters (or fallback to non-ML operations). In some cases, configuring 724 the UE 702 may be performed in a manner substantially similar to configuring 710 the UE 702.

FIG. 8 is a sequence diagram illustrating another example technique 800 for functionality based two-sided machine learning operations, in accordance with aspects of the present disclosure. Generally, in technique 800, a network entity 804 may play less of a role in determining what operations and/or features should be used. In technique 800, a UE 802 may be communicatively coupled to the network entity 804. Optionally, in some cases, the UE 802 may transmit 806 an indication of a set of UE operations performed (e.g., a second set of operations) and/or UE parameters (e.g., a second set of parameters) used by the UE 802 using ML models to the network entity 804. In some cases, the UE operations performed and/or UE parameters used may be transmitted 706 via control signaling, such as RRC signaling, as a part of a capability exchange, such as a part of capability information, higher level signaling, or the like.

In some cases, the network entity 804 may transmit 808 an indication of a set of network entity operations (e.g., a first set of operations) performed by the network entity 804 using ML models to the UE 802. In some cases, the network entity 804 may transmit 808 a set of network entity parameters (e.g., a first set of parameters) associated with the ML models being used. The set of network entity parameters may be transmitted 808 along with, or instead of the set of network entity operations. In some cases, the set of network entity parameters may be grouped so the grouping indicates the network entity parameters that may be input on a per ML model basis. In some cases, there may be an indication of the associated ML model for the grouped network entity parameters. In some cases, the set of network entity operations may be transmitted 808 via unicast or multicast control signaling, or broadcast by the network entity 804.

In some examples, the UE 802 may determine a set of compatible UE operations performed by and/or UE parameters used by ML models of the UE 802. Based on this determined set of compatible UE operations and/or UE parameters, the UE 802 may perform one or more UE operations and/or UE parameters.

In some cases, the network entity 804 may detect potential changes in network entity operations and/or network entity parameters 810. For example, environmental changes, such as interference from other wireless devices or weather changes may cause the network entity 804 to determine that a band, frequency, antenna pattern, and/or the like may be adjusted to reduce interference. In some cases, such as if the network entity 804 or UE 802 had previously activated/deactivated a UE operation and/or use of certain parameters, the network entity 804 may determine reactivating/deactivating the previously activated/deactivated UE operation and/or use of certain parameters may be useful for adapting to the potential change in the network entity's operation and/or network entity parameters. In such a case, the network entity may send an indication to activate/deactivate 812 the UE operation and/or use of certain parameters. The UE 802 may then activate/deactivate UE operations and/or use of certain ML models accordingly.

In some cases, the network entity 804 may determine whether a corresponding change in

UE operations and/or UE parameters may be needed. This determination may be based on the set of UE operations and/or UE parameters received from the UE 802 (e.g., in transmission 806). In some cases, the network entity 704 may send an indication to activate and/or deactivate 812 a use of one or more UE operations and/or UE parameters. In some cases, the indication to activate and/or deactivate 812 may be sent via control signaling, such as using a PDCCH/PDSCH message, MAC CE, and the like. The UE 802 may then activate/deactivate UE operations and/or use of certain ML models accordingly.

In some cases, the UE 802 may determine that a UE operation and/or UE parameter may be changed. For example, in some cases, the UE 802 may detect certain environmental changes, such as moving from an indoor environment to an outdoor environment, and vice versa. Based on these environmental changes the UE 802 may detect potential changes in UE operations and/or UE parameters 814 and determine whether a corresponding change in UE operations and/or UE parameters may be needed. The determination whether a corresponding change in UE operations and/or UE parameters may be determined based on the indication of the set of network entity operations performed and/or set of network entity parameters used by the network entity 804 transmitted 808 by the network entity 804. If the UE 802 determines that changes in UE operations and/or UE parameters should be made, the UE 802 may autonomously activate/deactivate UE operations and/or use of certain ML models accordingly. When the UE 802 is configured to autonomously activate/deactivate UE operations and/or use of certain ML models, the UE 802 may notify 816 the network entity 804 of such UE operation and/or UE parameter changes. In some cases, the UE 802 may then implement the UE operation and/or UE parameter changes, or fallback to non-ML operations. In some cases, the notification 816 of UE operation and/or UE parameter changes may be sent via control signaling, such as using a PUCCH/PUSCH message,

MAC CE, RRC message, and the like.

FIG. 9 is a sequence diagram illustrating another example technique 900 for functionality based two-sided machine learning operations, in accordance with aspects of the present disclosure. Technique 900 is similar to technique 800 of FIG. 8 in that the network entity 90404 may play less of a role in determining what operations and/or features should be used by a UE 902. In technique 900, the UE 902 may be communicatively coupled to the network entity 904.

In some cases, the network entity 904 may transmit 906 a set of operation (e.g., a first set of operations) identifiers along with an indication of an applicability associated with the operation identifiers. The operation identifiers may be associated with processes (e.g., application or technique) that may be used to perform the operations and the applicability may be an indication of the operation associated with the process. In some cases, the applicability may be a listing of scenarios (e.g., configurations) where a ML model (or set of ML models) may be used. In some cases, the network entity 904 may also transmit 906 an indication of a set of network entity operations (e.g., a first set of operations) performed by the network entity 904 using ML models to the UE 902 and/or a set of network entity parameters (e.g., a first set of parameters) associated with the ML models being used. The set of network entity parameters may be transmitted 908 along with, or instead of the set of network entity operations. In some cases, the set of network entity parameters may be grouped so the grouping indicates the network entity parameters that may be input on a per ML model basis. In some cases, there may be an indication of the associated ML model for the grouped network entity parameters. In some cases, the set of network entity operations may be transmitted 906 via control signaling and may be transmitted as a unicast, multicast, or broadcast by the network entity 904.

In some cases, the network entity 904 may detect potential changes in network entity operations and/or network entity parameters 908. For example, environmental changes, such as interference from other wireless devices or weather changes may cause the network entity 904 to determine that a band, frequency, antenna pattern, and/or the like may be adjusted to reduce interference. In some cases, the network entity 904 may detect potential changes in network entity operations and/or network entity parameters 908 and determine that a change in network entity operations and/or network entity parameters may be useful. Based on the determination that network entity operations and/or network entity parameters may be changed, the network entity 904 may send assistance information 910 to the UE 902. In some cases, the assistance information 910 may indicate to the UE that the network entity operations and/or network entity parameters may change. In some cases, the UE 902 may determine, based on the assistance information and the transmitted 906 set of operation identifiers and indication of an applicability associated with the operation identifiers, whether corresponding UE operators and/or UE parameters should be changed as well to ensure compatibility between ML models of the UE 902 and ML models of the network entity 904. The UE 902 may then activate/deactivate UE operations, use of certain ML models, and/or fallback to non-ML techniques accordingly. In some cases, the assistance information may be transmitted in a UE assistance information message, which may be an RRC message that may be used in indicate to a UE various internal states/status of the network.

In some cases, the UE 902 may determine that a UE operation and/or UE parameter may be changed. For example, in some cases, the UE 902 may detect certain environmental changes, such as moving from an indoor environment to an outdoor environment, and vice versa. Based on these environmental changes the UE 902 may determine potential changes in UE operations and/or UE parameters 912 may be useful. The UE 902 may determine, based on the potential changes, the transmitted 906 set of operation identifiers, and indication of an applicability associated with the operation identifiers, whether corresponding network entity operators and/or network entity parameters should be changed as well to ensure compatibility between ML models of the UE 902 and ML models of the network entity 904. In some cases, the UE 902 may notify 914 the network entity 904 of such UE operation and/or UE parameter changes. In some cases, the UE 902 may then implement the UE operation and/or UE parameter changes, or fallback to non-ML operations. In some cases, the notification 914 of UE operation and/or UE parameter changes may be sent via control signaling, such as using a PUCCH/PUSCH message, MAC CE, RRC message, and the like.

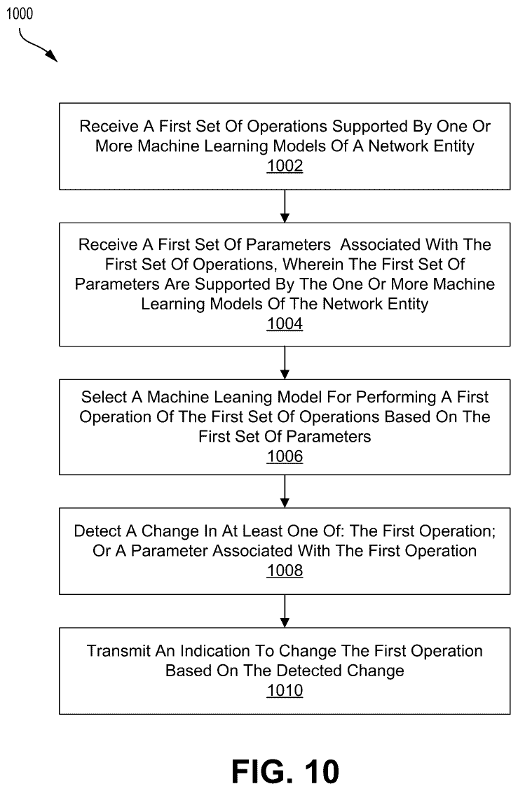

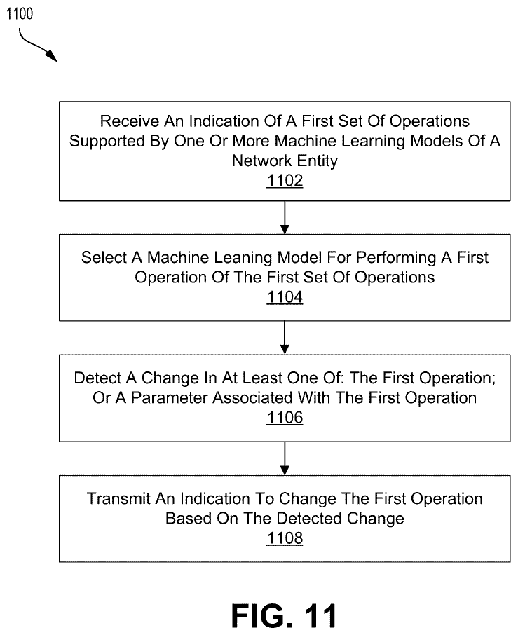

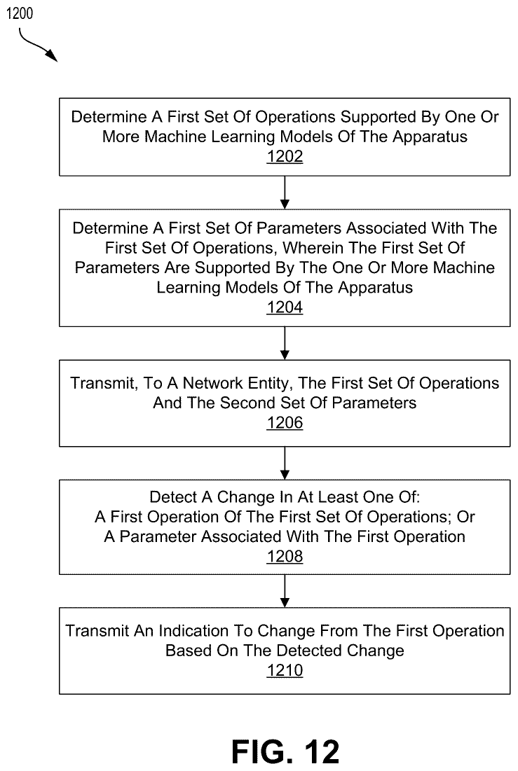

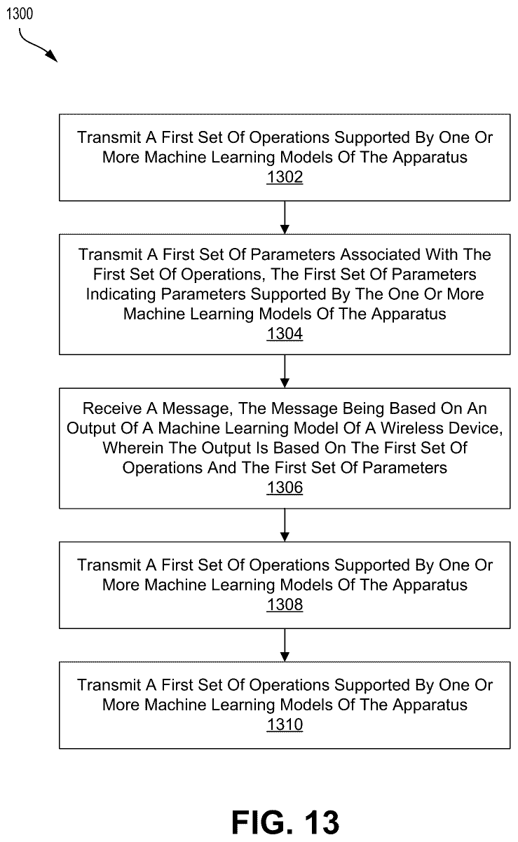

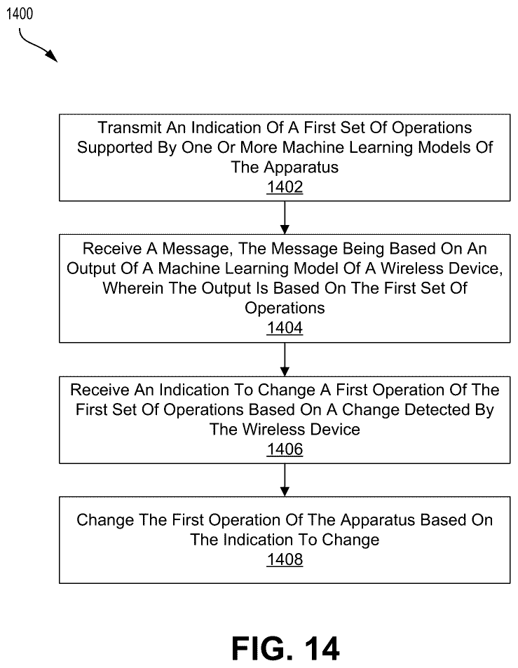

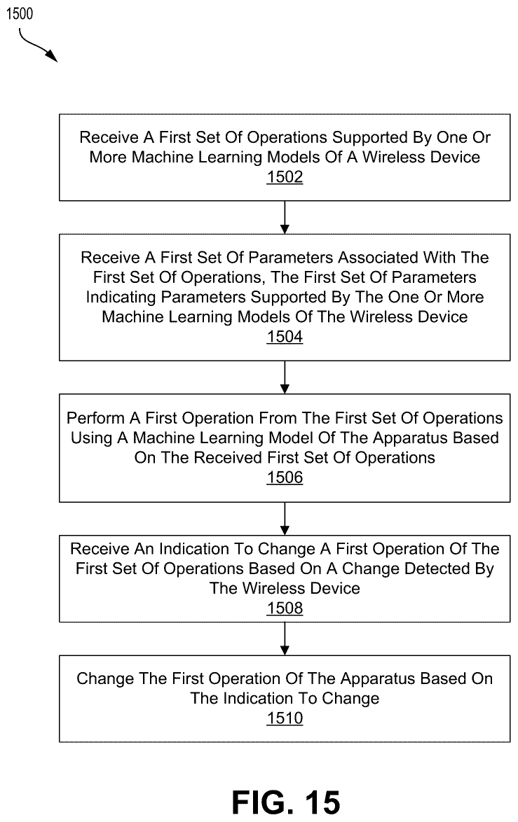

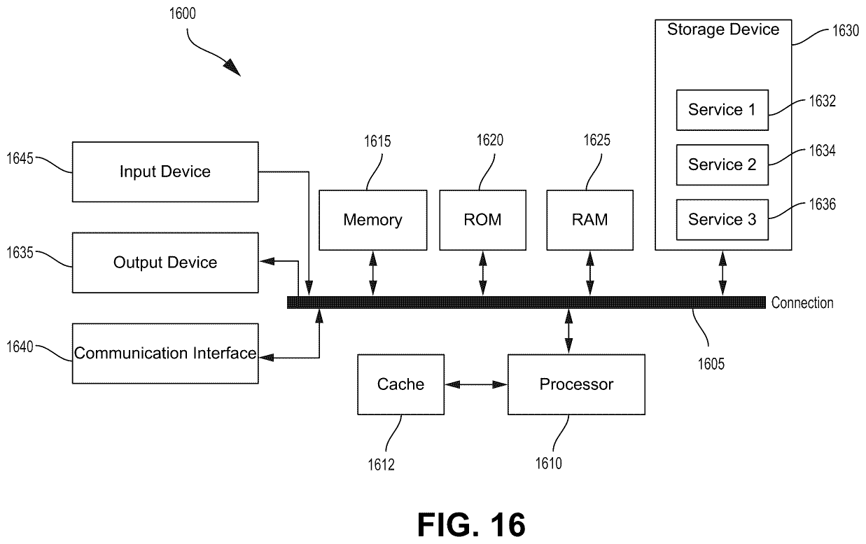

FIG. 10 is a flow diagram illustrating a process 1000 for performing wireless communications. The process 1000 can be performed by a wireless device (e.g., UE 104, UE 702, 802, and 902 of FIGS. 1, 2, 7, 8 and 9, respectively) or by a component or system (e.g., a chipset, one or more processors such as one or more microcontrollers, CPUs, DSPs, NPUs, NSPs, GPUs, ASICs, FPGAs, VPUs, etc.) of the wireless device. The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., processor 484 of FIG. 4, processor 1610 of FIG. 16 or other processor(s)). Further, the transmission and reception of signals by the wireless device in the process 1000 may be enabled, for example, by one or more antennas (e.g., antennas 252 of FIG. 2, antenna 487 of FIG. 4) and/or one or more transceivers (e.g., wireless transceiver(s) 478 of FIG. 4).

At block 1002, the computing device (or component thereof) may receive a first set of operations supported by one or more machine learning models of a network entity. The computing device (or component thereof) may determine a second set of operations supported by one or more machine learning models of the apparatus. The computing device (or component thereof) may determine a second set of parameters associated with the second set of operations. In some cases, the second set of parameters are supported by the one or more machine learning models of the apparatus. The computing device (or component thereof) may transmit, to the network entity, the second set of operations and the second set of parameters.

At block 1004, the computing device (or component thereof) may receive a first set of parameters associated with the first set of operations. In some cases, wherein the first set of parameters are supported by the one or more machine learning models of the network entity. In some cases, the first set of operations and the first set of parameters are based on the second set of operations and the second set of parameters. In some cases, the first set of operations and the first set of parameters are received via a unicast, multicast, or broadcast from the network entity.

At block 1006, the computing device (or component thereof) may select a machine learning model for performing a first operation of the first set of operations based on the first set of parameters. The computing device (or component thereof) may receive an activation message. In some cases, the activation message is configured to activate a second operation of the first set of operations. The computing device (or component thereof) may select a machine learning model to perform the second operation. The computing device (or component thereof) may receive a deactivation message. In some cases, the deactivation message specifies the first operation of the first set of operations. The computing device (or component thereof) may, based on the deactivation message, stop performing the first operation using the selected machine learning model. In some cases, the first operation comprises an encoding operation. In some cases, the first operation comprises encoding channel state information (CSI) feedback information.

At block 1008, the computing device (or component thereof) may detect a change in at least one of: the first operation; or a parameter associated with the first operation.

At block 1010, the computing device (or component thereof) may transmit an indication to change the first operation based on the detected change. In some cases, the indication to change the first operation based on the detected change comprises one of: an indication to deactivate the first operation; or an indication to activate a second operation. The computing device (or component thereof) may transmit, to the network entity, a message based on an output of the selected machine learning model. The computing device (or component thereof) may be configured to fallback to a non-machine learning model based way to perform the first operation.

FIG. 11 is a flow diagram illustrating a process 1100 for performing wireless communications. The process 1100 can be performed by a wireless device (e.g., UE 104, UE 702, 802, and 902 of FIGS. 1, 2, 7, 8 and 9, respectively) or by a component or system (e.g., a chipset, one or more processors such as one or more microcontrollers, CPUs, DSPs, NPUs, NSPs, GPUs, ASICs, FPGAs, VPUs, etc.) of the wireless device. The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1100 may be implemented as software components that are executed and run on one or more processors (e.g., processor 484 of FIG. 4, processor 1610 of FIG. 16 or other processor(s)). Further, the transmission and reception of signals by the wireless device in the process 1100 may be enabled, for example, by one or more antennas (e.g., antennas 252 of FIG. 2, antenna 487 of FIG. 4) and/or one or more transceivers (e.g., wireless transceiver(s) 478 of FIG. 4).

At block 1102, the computing device (or component thereof) may receive an indication of a first set of operations supported by one or more machine learning models of a network entity. In some cases, the indication of the first set of operations comprises a set of identifiers. In some cases, the set of identifiers comprise a respective identifier for each machine learning model of the one or more machine learning models of the network entity. The computing device (or component thereof) may determine a first set of parameters associated with the one or more machine learning models identified by the set of identifiers. In some cases, the first set of parameters indicating parameters supported by the one or more machine learning models of the network entity. In some cases, the set of identifiers indicate an operation applicability for operations of the first set of operations and parameters associated with operations of the first set of operations. In some cases, the set of identifiers indicate configurations for using operations of the first set of operations. In some cases, the indication of the first set of operations is received via a unicast, multicast, or broadcast from the network entity.

At block 1104, the computing device (or component thereof) may select a machine learning model for performing a first operation of the first set of operations. The computing device (or component thereof) may transmit, to the network entity, a message based on an output of the selected machine learning model. In some cases, the first operation comprises an encoding operation. In some cases, the first operation comprises encoding channel state information (CSI) feedback information.

At block 1106, the computing device (or component thereof) may detect a change in at least one of: the first operation; or a parameter associated with the first operation. The computing device (or component thereof) may receive an assistance message. The computing device (or component thereof) may select a second operation from the first set of operations based on the assistance message.

At block 1108, the computing device (or component thereof) may transmit an indication to change the first operation based on the detected change. In some cases, the indication to change the first operation based on the detected change comprises one of: an indication to deactivate the first operation; or an indication to activate a second operation. The computing device (or component thereof) may fallback to a non-machine learning model based way to perform the first operation.

FIG. 12 is a flow diagram illustrating a process 1000 2 or performing wireless communications. The process 1200 can be performed by a wireless device (e.g., UE 104, UE 702, 802, and 902 of FIGS. 1, 2, 7, 8 and 9, respectively) or by a component or system (e.g., a chipset, one or more processors such as one or more microcontrollers, CPUs, DSPs, NPUs, NSPs, GPUs, ASICs, FPGAs, VPUs, etc.) of the wireless device. The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1200 may be implemented as software components that are executed and run on one or more processors (e.g., processor 484 of FIG. 4, processor 1610 of FIG. 16 or other processor(s)). Further, the transmission and reception of signals by the wireless device in the process 1200 may be enabled, for example, by one or more antennas (e.g., antennas 252 of FIG. 2, antenna 487 of FIG. 4) and/or one or more transceivers (e.g., wireless transceiver(s) 478 of FIG. 4).

At block 1202, the computing device (or component thereof) may determine a first set of operations supported by one or more machine learning models of the apparatus.

At block 1204, the computing device (or component thereof) may determine a first set of parameters associated with the first set of operations. In some cases, the first set of parameters are supported by the one or more machine learning models of the apparatus. The computing device (or component thereof) may receive configuration information for a first operation of the first set of operations. The computing device (or component thereof) may perform the first operation based on the configuration information. In some cases, the received configuration information is based on the first set of operations and the first set of parameters. The computing device (or component thereof) may receive an activation message. In some cases, the activation message is configured to activate a second operation of the first set of operations. The computing device (or component thereof) may select a machine learning model to perform the second operation. The computing device (or component thereof) may receive a deactivation message. In some cases, the deactivation message specifies a first operation of the first set of operations. The computing device (or component thereof) may, based on the deactivation message, stop performing the first operation.

At block 1206, the computing device (or component thereof) may transmit, to a network entity, the first set of operations and the first set of parameters.

At block 1208, the computing device (or component thereof) may detect a change in at least one of: a first operation of the first set of operations or a parameter associated with the first operation. In some cases, the first operation comprises an encoding operation. In some cases, the first operation comprises encoding channel state information (CSI) feedback information.

At block 1210, the computing device (or component thereof) may transmit an indication to change from the first operation based on the detected change. In some cases, the indication to change comprises an indication to activate a second operation based on the detected change. In some cases, the indication to change comprises an indication to deactivate the first operation based on the detected change. In some cases, the indication to change includes an indication of the detected change to the network entity. The computing device (or component thereof) may receive at least one of a deactivation message or activation message. In some cases, at least one of the deactivation message or the activation message is based on the indication of the detected change. The computing device (or component thereof) may fallback to a non-machine learning model based way to perform the first operation.

FIG. 13 is a flow diagram illustrating a process 1300 for performing wireless communications. The process 1300 can be performed by a network entity (e.g., network entity 704, 804, and 904 of FIGS. 7, 8 and 9, respectively) or by a component or system (e.g., a chipset, one or more processors such as one or more microcontrollers, CPUs, DSPs, NPUs, NSPs, GPUs, ASICs, FPGAs, VPUs, etc.) of the network entity. The network entity can be or can be part of a base station (e.g., the base station 102 of FIG. 1 and FIG. 2). The operations of the process 1300 may be implemented as software components that are executed and run on one or more processors (e.g., processor 484 of FIG. 4, processor 1610 of FIG. 16, processor 1610 of FIG. 16, or other processor(s)). Further, the transmission and reception of signals by the first network entity in the process 1300 may be enabled, for example, by one or more antennas (e.g., antennas 234 of FIG. 2) and/or one or more transceivers (e.g., wireless transceiver(s), such as the transmit processor 220 and receive processor 238 of FIG. 2).

At block 1302, the computing device (or component thereof) may transmit a first set of operations supported by one or more machine learning models of the apparatus. The computing device (or component thereof) may receive, from the wireless device, a second set of operations supported by one or more machine learning models of the wireless device and a second set of parameters associated with the second set of operations. The computing device (or component thereof) may determine the first set of operations based on the second set of operations.

At block 1304, the computing device (or component thereof) may transmit a first set of parameters associated with the first set of operations. In some cases, the first set of parameters indicate parameters supported by the one or more machine learning models of the apparatus. The computing device (or component thereof) may transmit the first set of operations and the first set of parameters as a unicast, multicast, and/or broadcast message.

At block 1306, the computing device (or component thereof) may receive a message, the message being based on an output of a machine learning model of a wireless device. In some cases, the output is based on the first set of operations and the first set of parameters. The computing device (or component thereof) may transmit an activation message. In some cases, the activation message is configured to activate a second operation of the first set of operations. The computing device (or component thereof) may transmit a deactivation message. In some cases, the deactivation message specifies a first operation of the first set of operations.

At block 1308, the computing device (or component thereof) may receive an indication to change a first operation of the first set of operations based on a change detected by the wireless device. In some cases, the indication to change comprises an indication to activate a second operation. In some cases, to change the first operation, the computing device (or component thereof) may activate the second operation. In some cases, the indication to change comprises an indication to deactivate the first operation. In some cases, to change the first operation, the computing device (or component thereof) may deactivate the first operation. In some cases, the first operation comprises a decoding operation. In some cases, the first operation comprises encoding channel state information (CSI) feedback information.

At block 1310, the computing device (or component thereof) may change the first operation based on the indication to change.

FIG. 14 is a flow diagram illustrating a process 1400 for performing wireless communications. The process 1400 can be performed by a network entity (e.g., network entity 704, 804, and 904 of FIGS. 7, 8 and 9, respectively) or by a component or system (e.g., a chipset, one or more processors such as one or more microcontrollers, CPUs, DSPs, NPUs, NSPs, GPUs, ASICs, FPGAs, VPUs, etc.) of the network entity. The network entity can be or can be part of a base station (e.g., the base station 102 of FIG. 1 and FIG. 2). The operations of the process 1400 may be implemented as software components that are executed and run on one or more processors (e.g., processor 484 of FIG. 4, processor 1010 of FIG. 10, processor 1610 of FIG. 16, or other processor(s)). Further, the transmission and reception of signals by the first network entity in the process 1400 may be enabled, for example, by one or more antennas (e.g., antennas 234 of FIG. 2) and/or one or more transceivers (e.g., wireless transceiver(s), such as the transmit processor 220 and receive processor 238 of FIG. 2).

At block 1402, the computing device (or component thereof) may transmit an indication of a first set of operations supported by one or more machine learning models of the apparatus. In some cases, the indication of the first set of operations comprises a set of identifiers for the one or more machine learning models of a network entity. In some cases, the set of identifiers indicate an operation applicability for operations of the first set of operations and parameters associated with the operations of the first set of operations.

At block 1404, the computing device (or component thereof) may receive a message, the message being based on an output of a machine learning model of a wireless device. In some cases, the output is based on the first set of operations. The computing device (or component thereof) may detect a change in at least one of: a first operation of the first set of operations; or a parameter associated with the first operation. The computing device (or component thereof) may transmit an assistance message to the wireless device.

At block 1406, the computing device (or component thereof) may receive an indication to change (also referred to as an “change indication”) a first operation of the first set of operations based on a change detected by the wireless device. In some cases, the change indication comprises an indication that the wireless device activated a wireless device operation based on a change detected by the wireless device. In some cases, the change indication an indication that the wireless device deactivated a wireless device operation based on a change detected by the wireless device. In some cases, the first operation comprises a decoding operation. In some cases, the first operation comprises decoding channel state information (CSI) feedback information.

At block 1408, the computing device (or component thereof) may change the first operation of the apparatus based on the indication to change. In some cases, to change the first operation, the computing device (or component thereof) may perform at least one of: deactivate the first operation; activate the first operation; or fallback to a non-machine learning model based way to perform the first operation.

FIG. 15 is a flow diagram illustrating a process 1500 for performing wireless communications. The process 1500 can be performed by a network entity (e.g., network entity 704, 804, and 904 of FIGS. 7, 8 and 9, respectively) or by a component or system (e.g., a chipset, one or more processors such as one or more microcontrollers, CPUs, DSPs, NPUs, NSPs, GPUs, ASICs, FPGAs, VPUs, etc.) of the network entity. The network entity can be or can be part of a base station (e.g., the base station 102 of FIG. 1 and FIG. 2). The operations of the process 1500 may be implemented as software components that are executed and run on one or more processors (e.g., processor 484 of FIG. 4, processor 1010 of FIG. 10, processor 1610 of FIG. 16, or other processor(s)). Further, the transmission and reception of signals by the first network entity in the process 1500 may be enabled, for example, by one or more antennas (e.g., antennas 234 of FIG. 2) and/or one or more transceivers (e.g., wireless transceiver(s), such as the transmit processor 220 and receive processor 238 of FIG. 2).

At block 1502, the computing device (or component thereof) may receive a first set of operations supported by one or more machine learning models of a wireless device. The computing device (or component thereof) may transmit configuration information for the first operation of the first set of operations to the wireless device.

At block 1504, the computing device (or component thereof) may receive a first set of parameters associated with the first set of operations. In some cases, the first set of parameters indicate parameters supported by the one or more machine learning models of the wireless device.

At block 1506, the computing device (or component thereof) may perform a first operation from the first set of operations using a machine learning model of the apparatus based on the received first set of operations. The computing device (or component thereof) may detect a change in at least one of: the first operation or a parameter associated with the first operation. The computing device (or component thereof) may transmit an activation message. In some cases, the activation message activates a second operation of the first set of operations. The computing device (or component thereof) may detect a change in at least one of: the first operation or a parameter associated with the first operation. The computing device (or component thereof) may transmit an indication to deactivate the first operation based on the detected change. In some cases, the first operation comprises a decoding operation. In some cases, the first operation comprises decoding channel state information (CSI) feedback information.

At block 1508, the computing device (or component thereof) may receive an indication to change (also referred to as a change indication) a first operation of the first set of operations based on a change detected by the wireless device. In some cases, the change indication comprises an indication that the wireless device activated or deactivated a wireless device operation based on a change detected by the wireless device.

At block 1510, the computing device (or component thereof) may change the first operation of the apparatus based on the indication to change. The computing device (or component thereof) may determine to deactivate the first operation based on the received change indication. In some cases, based on determination to deactivate the first operation, the computing device (or component thereof) may transmit a deactivation message to the wireless device. The computing device (or component thereof) may determine to activate a second operation based on the received change indication. In some cases, based on determination to activate the second operation, the computing device (or component thereof) may transmit an activation message to the wireless device.

FIG. 16 is a diagram illustrating an example of a system for implementing certain aspects of the present technology. In particular, FIG. 16 illustrates an example of computing system 1600, which may be for example any computing device making up internal computing system, a remote computing system, a camera, or any component thereof in which the components of the system are in communication with each other using connection 1605. Connection 1605 may be a physical connection using a bus, or a direct connection into processor 1610, such as in a chipset architecture. Connection 1605 may also be a virtual connection, networked connection, or logical connection.

In some embodiments, computing system 1600 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1600 includes at least one processing unit (CPU or processor) 1610 and connection 1605 that communicatively couples various system components including system memory 1615, such as read-only memory (ROM) 1620 and random access memory (RAM) 1625 to processor 1610. Computing system 1600 may include a cache 1612 of high-speed memory connected directly with, in close proximity to, or integrated as part of processor 1610.

Processor 1610 may include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which may represent any number of input mechanisms, such as a microphone for speech, a touch-sensitive screen for gesture or graphical input, keyboard, mouse, motion input, speech, etc. Computing system 1600 may also include output device 1635, which may be one or more of a number of output mechanisms. In some instances, multimodal systems may enable a user to provide multiple types of input/output to communicate with computing system 1600.

Computing system 1600 may include communications interface 1640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1630 may include software services, servers, services, etc., that when the code that defines such software is executed by the processor 1610, it causes the system to perform a function. In some embodiments, a hardware service that performs a particular function may include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communications, the apparatus comprising: at least one memory; and at least one processor coupled to the at least one memory, the at least one processor being configured to: receive a first set of operations supported by one or more machine learning models of a network entity; receive a first set of parameters associated with the first set of operations, wherein the first set of parameters are supported by the one or more machine learning models of the network entity; select a machine learning model for performing a first operation of the first set of operations based on the first set of parameters; detect a change in at least one of: the first operation; or a parameter associated with the first operation; and transmit an indication to change the first operation based on the detected change.

Aspect 2. The apparatus of Aspect 1, wherein the at least one processor is further configured to: determine a second set of operations supported by one or more machine learning models of the apparatus; determine a second set of parameters associated with the second set of operations, wherein the second set of parameters are supported by the one or more machine learning models of the apparatus; and transmit, to the network entity, the second set of operations and the second set of parameters.

Aspect 3. The apparatus of Aspect 2, wherein the first set of operations and the first set of parameters are based on the second set of operations and the second set of parameters.

Aspect 4. The apparatus of any of Aspects 1-3, wherein the first set of operations and the first set of parameters are received in a unicast, multicast, or broadcast from the network entity.

Aspect 5. The apparatus of any of Aspects 1-4, wherein the at least one processor is further configured to: receive an activation message, wherein the activation message is configured to activate a second operation of the first set of operations; and select a machine learning model to perform the second operation.

Aspect 6. The apparatus of any of Aspects 1-5, wherein the at least one processor is further configured to: receive a deactivation message, wherein the deactivation message specifies the first operation of the first set of operations; and based on the deactivation message, stop performing the first operation using the selected machine learning model.

Aspect 7. The apparatus of any of Aspects 1-6, wherein the indication to change the first operation based on the detected change comprises one of: an indication to deactivate the first operation; or an indication to activate a second operation.

Aspect 8. The apparatus of any of Aspects 1-7, wherein the at least one processor is further configured to transmit, to the network entity, a message based on an output of the selected machine learning model.

Aspect 9. The apparatus of any of any of Aspects 1-8, wherein the first operation comprises an encoding operation.

Aspect 10. The apparatus of Aspect 9, wherein the first operation comprises encoding channel state information (CSI) feedback information.

Aspect 11. The apparatus of any of Aspects 1-10, wherein the at least one processor is further configured to fallback to a non-machine learning model based way to perform the first operation.

Aspect 12. An apparatus for wireless communications, the apparatus comprising: at least one memory; and at least one processor coupled to the at least one memory, the at least one processor being configured to: receive an indication of a first set of operations supported by one or more machine learning models of a network entity; select a machine learning model for performing a first operation of the first set of operations; detect a change in at least one of: the first operation; or a parameter associated with the first operation; and transmit an indication to change the first operation based on the detected change.

Aspect 13. The apparatus of Aspect 12, wherein the indication of the first set of operations comprises a set of identifiers, the set of identifiers comprising a respective identifier for each machine learning model of the one or more machine learning models of the network entity.

Aspect 14. The apparatus of Aspect 13, wherein the at least one processor is further configured to determine a first set of parameters associated with the one or more machine learning models identified by the set of identifiers, the first set of parameters indicating parameters supported by the one or more machine learning models of the network entity.

Aspect 15. The apparatus of any of Aspects 13-14, wherein the set of identifiers indicates an operation applicability for operations of the first set of operations and parameters associated with operations of the first set of operations.

Aspect 16. The apparatus of any of Aspects 13-15, wherein the set of identifiers indicates configurations for using operations of the first set of operations.

Aspect 17. The apparatus of any of Aspects 12-16, wherein the at least one processor is configured to receive the indication of the first set of operations in a unicast, multicast, or broadcast from the network entity.

Aspect 18. The apparatus of any of Aspects 12-17, wherein the at least one processor is further configured to: receive an assistance message; and select a second operation from the first set of operations based on the assistance message.

Aspect 19. The apparatus of any of Aspects 12-18, wherein the indication to change the first operation based on the detected change comprises one of: an indication to deactivate the first operation; or an indication to activate a second operation.

Aspect 20. The apparatus of any of Aspects 12-19, wherein the at least one processor is further configured to transmit, to the network entity, a message based on an output of the selected machine learning model.

Aspect 21. The apparatus of any of Aspects 12-20, wherein the first operation comprises an encoding operation.

Aspect 22. The apparatus of any of Aspects 12-21, wherein the first operation comprises encoding channel state information (CSI) feedback information.

Aspect 23. The apparatus of any of Aspects 12-22, wherein the at least one processor is further configured to fallback to a non-machine learning model based way to perform the first operation.

Aspect 24. An apparatus for wireless communications, the apparatus comprising: at least one memory; and at least one processor coupled to the at least one memory, the at least one processor being configured to: determine a first set of operations supported by one or more machine learning models of the apparatus; determine a first set of parameters associated with the first set of operations, wherein the first set of parameters are supported by the one or more machine learning models of the apparatus; transmit, to a network entity, the first set of operations and the first set of parameters; detect a change in at least one of: a first operation of the first set of operations; or a parameter associated with the first operation; and transmit an indication to change from the first operation based on the detected change.

Aspect 25. The apparatus of Aspect 24, wherein the at least one processor is further configured to: receive configuration information for a first operation of the first set of operations; and perform the first operation based on the configuration information.

Aspect 26. The apparatus of Aspect 25, wherein the received configuration information is based on the first set of operations and the first set of parameters.

Aspect 27. The apparatus of any of Aspects 24-26, wherein the at least one processor is further configured to: receive an activation message, wherein the activation message is configured to activate a second operation of the first set of operations; and select a machine learning model to perform the second operation.

Aspect 28. The apparatus of any of Aspects 24-27, wherein the at least one processor is further configured to: receive a deactivation message, wherein the deactivation message specifies a first operation of the first set of operations; and based on the deactivation message, stop performing the first operation.

Aspect 29. The apparatus of any of Aspects 24-28, wherein the indication to change comprises an indication to activate a second operation based on the detected change.

Aspect 30. The apparatus of any of Aspects 24-29, wherein the indication to change comprises an indication to deactivate the first operation based on the detected change.

Aspect 31. The apparatus of any of Aspects 24-30, wherein the indication to change includes an indication of the detected change to the network entity.

Aspect 32. The apparatus of Aspect 31, wherein the at least one processor is further configured to: receive at least one of a deactivation message or activation message, wherein at least one of the deactivation message or the activation message is based on the indication of the detected change.

Aspect 33. The apparatus of any of Aspects 24-32, wherein the first operation comprises an encoding operation.

Aspect 34. The apparatus of Aspect 33, wherein the first operation comprises encoding channel state information (CSI) feedback information.

Aspect 35. The apparatus of any of Aspects 24-34, wherein the at least one processor is further configured to fallback to a non-machine learning model based way to perform the first operation.

Aspect 36. An apparatus for wireless communications, the apparatus comprising: at least one memory; and at least one processor coupled to the at least one memory, the at least one processor being configured to: transmit a first set of operations supported by one or more machine learning models of the apparatus; transmit a first set of parameters associated with the first set of operations, the first set of parameters indicating parameters supported by the one or more machine learning models of the apparatus; receive a message, the message being based on an output of a machine learning model of a wireless device, wherein the output is based on the first set of operations and the first set of parameters; receive an indication to change a first operation of the first set of operations based on a change detected by the wireless device; and change the first operation based on the indication to change.

Aspect 37. The apparatus of Aspect 36, wherein the at least one processor is configured to transmit the first set of operations and the first set of parameters as a unicast message, a multicast message, or a broadcast message.

Aspect 38. The apparatus of any of Aspects 36-37, wherein the at least one processor is further configured to: receive, from the wireless device, a second set of operations supported by one or more machine learning models of the wireless device and a second set of parameters associated with the second set of operations; and determine the first set of operations based on the second set of operations.

Aspect 39. The apparatus of Aspect 38, wherein the at least one processor is further configured to transmit an activation message, wherein the activation message is configured to activate a second operation of the first set of operations.

Aspect 40. The apparatus of any of Aspects 38-39, wherein the at least one processor is further configured to transmit a deactivation message, wherein the deactivation message specifies a first operation of the first set of operations.

Aspect 41. The apparatus of any of Aspects 38-40, wherein the indication to change comprises an indication to activate a second operation; and wherein, to change the first operation, the at least one processor is configured to activate the second operation.

Aspect 42. The apparatus of any of Aspects 38-41, wherein the indication to change comprises an indication to deactivate the first operation; and wherein, to change the first operation, the at least one processor is configured to deactivate the first operation.

Aspect 43. The apparatus of any of Aspects 38-42, wherein the first operation comprises a decoding operation.

Aspect 44. The apparatus of Aspect 43, wherein the first operation comprises encoding channel state information (CSI) feedback information.

Aspect 45. An apparatus for wireless communications, the apparatus comprising: at least one memory; and at least one processor coupled to the at least one memory, the at least one processor being configured to: transmit an indication of a first set of operations supported by one or more machine learning models of the apparatus; receive a message, the message being based on an output of a machine learning model of a wireless device, wherein the output is based on the first set of operations; receive an indication to change a first operation of the first set of operations based on a change detected by the wireless device; and change the first operation of the apparatus based on the indication to change.

Aspect 46. The apparatus of Aspect 45, wherein the indication of the first set of operations comprises a set of identifiers for the one or more machine learning models of a network entity.

Aspect 47. The apparatus of Aspect 46, wherein the set of identifiers indicates an operation applicability for operations of the first set of operations and parameters associated with the operations of the first set of operations.

Aspect 48. The apparatus of any of Aspects 46-47, wherein the set of identifiers indicates configurations for using operations of the first set of operations.

Aspect 49. The apparatus of any of Aspects 45-49, wherein the at least one processor is further configured to: detect a change in at least one of: a first operation of the first set of operations; or a parameter associated with the first operation; and transmit an assistance message to the wireless device.

Aspect 50. The apparatus of any of Aspects 45-49, wherein the indication to change comprises an indication that the wireless device activated a wireless device operation based on a change detected by the wireless device.

Aspect 51. The apparatus of any of Aspects 45-50, wherein the indication to change comprises of: an indication that the wireless device deactivated a wireless device operation based on a change detected by the wireless device.

Aspect 52. The apparatus of any of Aspects 45-51, wherein, to change the first operation, the at least one processor is configured to perform at least one of: deactivate the first operation; activate the first operation; or fallback to a non-machine learning model based way to perform the first operation.

Aspect 53. The apparatus of any of Aspects 45-52, wherein the first operation comprises a decoding operation.

Aspect 54. The apparatus of Aspect 53, wherein the first operation comprises decoding channel state information (CSI) feedback information.

Aspect 55. An apparatus for wireless communications, the apparatus comprising: at least one memory; and at least one processor coupled to the at least one memory, the at least one processor being configured to: receive a first set of operations supported by one or more machine learning models of a wireless device; receive a first set of parameters associated with the first set of operations, the first set of parameters indicating parameters supported by the one or more machine learning models of the wireless device; perform a first operation from the first set of operations using a machine learning model of the apparatus based on the received first set of operations; receive an indication to change a first operation of the first set of operations based on a change detected by the wireless device; and change the first operation of the apparatus based on the indication to change.

Aspect 56. The apparatus of Aspect 55, wherein the at least one processor is further configured to transmit configuration information for the first operation of the first set of operations to the wireless device.

Aspect 57. The apparatus of any of Aspects 55-56, wherein the at least one processor is further configured to: detect a change in at least one of: the first operation; or a parameter associated with the first operation; and transmit an activation message, wherein the activation message activates a second operation of the first set of operations.

Aspect 58. The apparatus of any of Aspects 55-57, wherein the at least one processor is further configured to: detect a change in at least one of: the first operation; or a parameter associated with the first operation; and transmit an indication to deactivate the first operation based on the detected change.

Aspect 59. The apparatus of any of Aspects 55-58, wherein the indication to change comprises an indication that the wireless device activated or deactivated a wireless device operation based on a change detected by the wireless device.

Aspect 60. The apparatus of any of Aspects 55-59, wherein the at least one processor is further configured to: determine to deactivate the first operation based on the received indication to change; and based on determination to deactivate the first operation, transmit a deactivation message to the wireless device.

Aspect 61. The apparatus of any of Aspects 55-60, wherein the at least one processor is further configured to: determine to activate a second operation based on the received indication to change; and based on determination to activate the second operation, transmit an activation message to the wireless device.

Aspect 62. The apparatus of any of Aspects 55-61, wherein the first operation comprises a decoding operation.

Aspect 63. The apparatus of any of Aspects 55-62, wherein the first operation comprises decoding channel state information (CSI) feedback information.

Aspect 64. A method for wireless communications comprising performing operations according to any of Aspects 1-11.

Aspect 65. A non-transitory computer-readable storage medium comprising instructions stored thereon which, when executed by at least one processor, causes the at least one processor to perform operations according to any of Aspects 1-11.

Aspect 66. An apparatus for wireless communications comprising one or more means for performing operations according to any of Aspects 1-11.

Aspect 67. A method for wireless communications comprising performing operations according to any of Aspects 12-23.

Aspect 68. A non-transitory computer-readable storage medium comprising instructions stored thereon which, when executed by at least one processor, causes the at least one processor to perform operations according to any of Aspects 12-23.

Aspect 69. An apparatus for wireless communications comprising one or more means for performing operations according to any of Aspects 12-23.

Aspect 70. A method for wireless communications comprising performing operations according to any of Aspects 24-35.

Aspect 71. A non-transitory computer-readable storage medium comprising instructions stored thereon which, when executed by at least one processor, causes the at least one processor to perform operations according to any of Aspects 24-35.

Aspect 72. An apparatus for wireless communications comprising one or more means for performing operations according to any of Aspects 24-35.

Aspect 73. A method for wireless communications comprising performing operations according to any of Aspects 36-44.

Aspect 74. A non-transitory computer-readable storage medium comprising instructions stored thereon which, when executed by at least one processor, causes the at least one processor to perform operations according to any of Aspects 36-44.

Aspect 75. An apparatus for wireless communications comprising one or more means for performing operations according to any of Aspects 36-44.

Aspect 78. A method for wireless communications comprising performing operations according to any of Aspects 45-54.

Aspect 79. A non-transitory computer-readable storage medium comprising instructions stored thereon which, when executed by at least one processor, causes the at least one processor to perform operations according to any of Aspects 45-54.

Aspect 80. An apparatus for wireless communications comprising one or more means for performing operations according to any of Aspects 45-54.

Aspect 81. A method for wireless communications comprising performing operations according to any of Aspects 55-63.

Aspect 82. A non-transitory computer-readable storage medium comprising instructions stored thereon which, when executed by at least one processor, causes the at least one processor to perform operations according to any of Aspects 55-63.

Aspect 83. An apparatus for wireless communications comprising one or more means for performing operations according to any of Aspects 55-63.

What is claimed is:

1. An apparatus for wireless communications, the apparatus comprising:
at least one memory; and
at least one processor coupled to the at least one memory, the at least one processor being configured to:
receive a first set of operations supported by one or more machine learning models of a network entity;
receive a first set of parameters associated with the first set of operations, wherein the first set of parameters are supported by the one or more machine learning models of the network entity;
select a machine learning model for performing a first operation of the first set of operations based on the first set of parameters;
detect a change in at least one of:
the first operation; or
a parameter associated with the first operation; and
transmit an indication to change the first operation based on the detected change.

2. The apparatus of claim 1, wherein the at least one processor is further configured to:
determine a second set of operations supported by one or more machine learning models of the apparatus;
determine a second set of parameters associated with the second set of operations, wherein the second set of parameters are supported by the one or more machine learning models of the apparatus; and
transmit, to the network entity, the second set of operations and the second set of parameters.

3. The apparatus of claim 2, wherein the first set of operations and the first set of parameters are based on the second set of operations and the second set of parameters.

4. The apparatus of claim 1, wherein the first set of operations and the first set of parameters are received in a unicast, multicast, or broadcast from the network entity.

5. The apparatus of claim 1, wherein the at least one processor is further configured to:
receive an activation message, wherein the activation message is configured to activate a second operation of the first set of operations; and
select a machine learning model to perform the second operation.

6. The apparatus of claim 1, wherein the at least one processor is further configured to:
receive a deactivation message, wherein the deactivation message specifies the first operation of the first set of operations; and
based on the deactivation message, stop performing the first operation using the selected machine learning model.

7. The apparatus of claim 1, wherein the at least one processor is further configured to transmit, to the network entity, a message based on an output of the selected machine learning model.

8. An apparatus for wireless communications, the apparatus comprising:
at least one memory; and
at least one processor coupled to the at least one memory, the at least one processor being configured to:
receive an indication of a first set of operations supported by one or more machine learning models of a network entity;
select a machine learning model for performing a first operation of the first set of operations;
detect a change in at least one of:
the first operation; or
a parameter associated with the first operation; and
transmit an indication to change the first operation based on the detected change.

9. The apparatus of claim 8, wherein the indication of the first set of operations comprises a set of identifiers, the set of identifiers comprising a respective identifier for each machine learning model of the one or more machine learning models of the network entity.

10. The apparatus of claim 9, wherein the at least one processor is further configured to determine a first set of parameters associated with the one or more machine learning models identified by the set of identifiers, the first set of parameters indicating parameters supported by the one or more machine learning models of the network entity.

11. The apparatus of claim 9, wherein the set of identifiers indicates an operation applicability for operations of the first set of operations and parameters associated with operations of the first set of operations.

12. The apparatus of claim 9, wherein the set of identifiers indicates configurations for using operations of the first set of operations.

13. The apparatus of claim 8, wherein the at least one processor is configured to receive the indication of the first set of operations in a unicast, multicast, or broadcast from the network entity.

14. The apparatus of claim 8, wherein the at least one processor is further configured to:
receive an assistance message; and
select a second operation from the first set of operations based on the assistance message.

15. The apparatus of claim 8, wherein the at least one processor is further configured to transmit, to the network entity, a message based on an output of the selected machine learning model.

16. An apparatus for wireless communications, the apparatus comprising:
at least one memory; and
at least one processor coupled to the at least one memory, the at least one processor being configured to:
determine a first set of operations supported by one or more machine learning models of the apparatus;
determine a first set of parameters associated with the first set of operations, wherein the first set of parameters are supported by the one or more machine learning models of the apparatus;
transmit, to a network entity, the first set of operations and the first set of parameters;
detect a change in at least one of:
a first operation of the first set of operations; or
a parameter associated with the first operation; and
transmit an indication to change from the first operation based on the detected change.

17. The apparatus of claim 16, wherein the at least one processor is further configured to:
receive configuration information for a first operation of the first set of operations; and
perform the first operation based on the configuration information.

18. The apparatus of claim 17, wherein the received configuration information is based on the first set of operations and the first set of parameters.

19. The apparatus of claim 16, wherein the at least one processor is further configured to:
receive an activation message, wherein the activation message is configured to activate a second operation of the first set of operations; and
select a machine learning model to perform the second operation.

20. The apparatus of claim 16, wherein the at least one processor is further configured to:
receive a deactivation message, wherein the deactivation message specifies a first operation of the first set of operations; and
based on the deactivation message, stop performing the first operation.

21. The apparatus of claim 16, wherein the indication to change includes an indication of the detected change to the network entity.

22. An apparatus for wireless communications, the apparatus comprising:
at least one memory; and
at least one processor coupled to the at least one memory, the at least one processor being configured to:
transmit a first set of operations supported by one or more machine learning models of the apparatus;
transmit a first set of parameters associated with the first set of operations, the first set of parameters indicating parameters supported by the one or more machine learning models of the apparatus;
receive a message, the message being based on an output of a machine learning model of a wireless device, wherein the output is based on the first set of operations and the first set of parameters;
receive an indication to change a first operation of the first set of operations based on a change detected by the wireless device; and
change the first operation based on the indication to change.

23. The apparatus of claim 22, wherein the at least one processor is configured to transmit the first set of operations and the first set of parameters as a unicast message, a multicast message, or a broadcast message.

24. The apparatus of claim 22, wherein the at least one processor is further configured to:
receive, from the wireless device, a second set of operations supported by one or more machine learning models of the wireless device and a second set of parameters associated with the second set of operations; and
determine the first set of operations based on the second set of operations.

25. The apparatus of claim 22, wherein the at least one processor is further configured to transmit an activation message, wherein the activation message is configured to activate a second operation of the first set of operations.

26. The apparatus of claim 22, wherein the at least one processor is further configured to transmit a deactivation message, wherein the deactivation message specifies a first operation of the first set of operations.
